(19) United States
(12) Patent Application Publication
(10) Pub. No.: US 2025/0063599 A1
(43) Pub. Date: Feb. 20, 2025

(54) INITIAL ACCESS AND DEVICE IDENTIFICATION PROTOCOL DESIGN FOR PASSIVE INTERNET OF THINGS

(71) Applicant: QUALCOMM Incorporated, San Diego, CA (US)

(72) Inventors: Chao WEI, Beijing (CN); Rui HU, Beijing (CN); Min HUANG, Beijing (CN); Kangqi LIU, San Diego, CA (US); Mingxi YIN, Beijing (CN); Hao XU, Beijing (CN); Wanshi CHEN, San Diego, CA (US); Peter GAAL, San Diego, CA (US)

(21) Appl. No.: 18/721,807

(22) PCT Filed: Mar. 2, 2022
(86) PCT No.: PCT/CN2022/078803

§ 371 Date: Jun. 19, 2024

(51) Int. Cl. H04W 74/0816; H04L 1/08; H04L 5/00; H04W 72/02; H04W 74/08

(52) U.S. Cl. CPC H04W 74/0816; H04L 1/08; H04L 5/0053; H04W 72/02; H04W 74/0875

(57) ABSTRACT

Methods, systems, and devices for wireless communications are described. A network entity (e.g., a base station or reader) may transmit an initial access trigger message (e.g., modulating a continuous wave transmission using amplitude shift keying (ASK)), and the trigger message may include an indication of a type of passive user equipment (PUE) or a PUE use case (e.g., high priority/latency-critical PUEs or low priority/latency non-critical PUEs). A receiving PUE may harvest energy from the initial access trigger message for transmitting an initial access response message including an identifier for the receiving PUE. The receiving PUE may transmit the initial access response message (e.g., on one or more initial access resources) using the harvested energy if the trigger message indicates the PUE's type of PUE or PUE use case. In some examples, the receiving PUE may ignore triggers for different types of PUEs or PUE use cases.

### CROSS REFERENCE

The present application is a 371 national stage filing of International PCT Application No. PCT/CN2022/078803 by WEI et al. entitled “INITIAL ACCESS AND DEVICE IDENTIFICATION PROTOCOL DESIGN FOR PASSIVE INTERNET OF THINGS,” filed Mar. 2, 2022, which is assigned to the assignee hereof, and which is expressly incorporated by reference in its entirety herein.

### TECHNICAL FIELD

The following relates to wireless communications, including initial access and device identification protocol design for passive Internet of Things.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support passive Internet of Things (IoT) systems.

### SUMMARY

The described techniques relate to improved methods, systems, devices, and apparatuses that support initial access and device identification protocol design for passive Internet of Things (IoT). For example, the described techniques may provide for efficient resource utilization in IoT communications networks by configuring a use case dependent initial access control. A network entity (e.g., a base station or reader) may transmit an initial access trigger message (e.g., modulating a continuous wave transmission using amplitude shift keying (ASK)), and the trigger message may include an indication of a type of passive user equipment (PUE) or PUE use case (e.g., high priority/latency-critical PUEs or low priority/latency non-critical PUEs). A receiving PUE may harvest energy from the initial access trigger message for transmitting an initial access response message including an identifier for the receiving PUE via backscatter signaling. The receiving PUE may transmit the initial access response message (e.g., on one or more initial access resources) using the harvested energy if the trigger message indicates the PUE's type of PUE or corresponding PUE use case. In some examples, the receiving PUE may ignore triggers for different types of PUEs or PUE use cases. In some examples, for the PUE type or PUE use case associated with latency critical access, the trigger command may be sent periodically, and the PUE may adapt its response rate to the trigger command based on a timing budget to transmit data. In some examples, latency non-critical PUEs, or PUEs operating according to a latency non-critical use case, may be grouped into different frames, slots, and frequency channels to restrict the total number of PUEs to access at the same time. In some examples, a PUE of either type or use case may be muted after a successful response. Alternatively, a network entity may schedule retransmissions, where a PUE performing retransmissions during multiple configured rounds of retransmissions may reduce its response rate after each round of retransmission. In some examples, frequencies of a power of 2 relative to a reference frequency may be used for frequency-division multiplexing (FDM) to mitigate harmonic interference.

A method for wireless communications at a passive user equipment (UE) is described. The method may include receiving, from a network entity, an initial access trigger message including an indication of a first type of passive UE of a set of multiple types of passive UEs, selecting one or more initial access resources based on the passive UE being the first type of passive UE, and transmitting, to the network entity on the one or more initial access resources, an initial access response message including an identifier associated with the passive UE.

An apparatus for wireless communications at a passive UE is described. The apparatus may include at least one processor, and memory coupled (e.g., operatively, communicatively, functionally, electronically, or electrically) to the at least one processor, the memory storing instructions executable by the at least one processor to cause the apparatus to receive, from a network entity, an initial access trigger message including an indication of a first type of passive UE of a set of multiple types of passive UEs, select one or more initial access resources based on the passive UE being the first type of passive UE, and transmit, to the network entity on the one or more initial access resources, an initial access response message including an identifier associated with the passive UE.

Another apparatus for wireless communications at a passive UE is described. The apparatus may include means for receiving, from a network entity, an initial access trigger message including an indication of a first type of passive UE of a set of multiple types of passive UEs, means for selecting one or more initial access resources based on the passive UE being the first type of passive UE, and means for transmitting, to the network entity on the one or more initial access resources, an initial access response message including an identifier associated with the passive UE.

A non-transitory computer-readable medium storing code for wireless communications at a passive UE is described. The code may include instructions executable by at least one processor to receive, from a network entity, an initial access trigger message including an indication of a first type of passive UE of a set of multiple types of passive UEs, select one or more initial access resources based on the passive UE being the first type of passive UE, and transmit, to the network entity on the one or more initial access resources, an initial access response message including an identifier associated with the passive UE.

Some examples of the method, apparatuses, and non-transitory computer-readable medium described herein may further include operations, features, means, or instructions for receiving, from the network entity based on transmitting the initial access response message, an initial access acknowledgment message including the identifier associated with the passive UE and transmitting, based on the initial access acknowledgment message, a data message to the network entity.

In some examples of the method, apparatuses, and non-transitory computer-readable medium described herein, transmitting the initial access response message may include operations, features, means, or instructions for transmitting the initial access response message according to a muting ratio associated with the first type of passive UE, where the first type of passive UE may be associated with sensor data transmissions of a first priority level and the second type of passive UE may be associated with pre-stored sensor data transmissions of a second priority level that may be lower than the first priority level.

Some examples of the method, apparatuses, and non-transitory computer-readable medium described herein may further include operations, features, means, or instructions for selecting, based on an amount of time in a timing budget for transmitting the data message, the muting ratio from a set of multiple candidate muting ratios of a set of multiple candidate muting ratios, each muting ratio of the set of multiple candidate muting ratios indicating a respective ratio between a number of initial access response messages and a set of periodic initial access trigger messages including the initial access trigger message, where the data message includes high priority sensor data.

Some examples of the method, apparatuses, and non-transitory computer-readable medium described herein may further include operations, features, means, or instructions for receiving, from the network entity, an indication of the set of multiple candidate muting ratios.

In some examples of the method, apparatuses, and non-transitory computer-readable medium described herein, transmitting the initial access response message may include operations, features, means, or instructions for generating a slot number associated with the one or more initial access resources from a set of slot numbers, where the initial access trigger message includes an indication of the set of slot numbers and transmitting the initial access response message when the generated slot number satisfies a condition.

Some examples of the method, apparatuses, and non-transitory computer-readable medium described herein may further include operations, features, means, or instructions for receiving, from then network entity, a first configuration message indicating a periodicity of a set of multiple access frames associated with the first type of passive UE and a number of available access frames of the set of multiple access frames during a first period, where a first access frame of the set of multiple access frames includes the one or more initial access resources, where the first type of passive UE may be associated with pre-stored sensor data transmissions of a first priority level and the second type of passive UE may be associated with sensor data transmissions of a second priority level that may be higher than the first priority level.

Some examples of the method, apparatuses, and non-transitory computer-readable medium described herein may further include operations, features, means, or instructions for determining the first access frame from the set of multiple access frames based on an identifier associated with the passive UE, the periodicity, the number of available access frames, or a combination thereof and randomly selecting the one or more initial access resources from a set of time resources associated with the first access frame, a set of frequency resources associated with the first access frame, or both.

Some examples of the method, apparatuses, and non-transitory computer-readable medium described herein may further include operations, features, means, or instructions for receiving, from the network entity, a second configuration message including an indication of a number of time resources associated with each respective access frame of the set of multiple access frames during the first period, a number of frequency resources associated with each respective access frame of the set of multiple access frames during the first period, or a combination thereof.

Some examples of the method, apparatuses, and non-transitory computer-readable medium described herein may further include operations, features, means, or instructions for receiving, from the network entity, a third configuration message including an indication of a second number of time resources associated with each respective access frame of the set of multiple access frames during a second period, a second number of frequency resources associated with each respective access frame of the set of multiple access frames during the second period, or a combination thereof.

Some examples of the method, apparatuses, and non-transitory computer-readable medium described herein may further include operations, features, means, or instructions for receiving, from the network entity, a second initial access trigger message including a second indication of the first type of passive UE and refraining from transmitting a second initial access response message based on transmitting the initial access response message.

Some examples of the method, apparatuses, and non-transitory computer-readable medium described herein may further include operations, features, means, or instructions for adjusting a response rate, a muting ratio, or a combination thereof, based on transmitting the initial access response message, where the refraining may be based on the adjusting.

Some examples of the method, apparatuses, and non-transitory computer-readable medium described herein may further include operations, features, means, or instructions for receiving, from the network entity based on transmitting the initial access response message, an instruction to retransmit the initial access response message and retransmitting the initial access response message to the network entity based on the instruction.

Some examples of the method, apparatuses, and non-transitory computer-readable medium described herein may further include operations, features, means, or instructions for receiving, in the instruction to retransmit the initial access response message, an indication of a subset of retransmission resources of a set of multiple retransmission resources during which the passive UE may be permitted to retransmit the initial access response message and determining a response rate for a retransmission of the initial access response message where retransmitting the initial access response message includes retransmitting the initial access response message according to the response rate using one or more of the subset of retransmission resources.

Some examples of the method, apparatuses, and non-transitory computer-readable medium described herein may further include operations, features, means, or instructions for receiving, from the network entity, an indication of a supported frequency shift for subcarrier modulation and performing, based on the supported frequency shift and a number of frequency channels indicated for the one or more initial access resources in the initial access trigger message, a subcarrier modulation procedure, where transmitting the initial access response message may be based on the subcarrier modulation procedure.

In some examples of the method, apparatuses, and non-transitory computer-readable medium described herein, transmitting the initial access response message may include operations, features, means, or instructions for modulating a first carrier signal associated with the initial access trigger message and backscattering a second carrier signal based on the modulated first carrier signal, where the second carrier signal includes the initial access response message.

A method for wireless communications at a network entity is described. The method may include transmitting, to a first passive UE, an initial access trigger message including an indication of a first type of passive UE of a set of multiple types of passive UEs and receiving, from the first passive UE based on the first passive UE being the first type of UE, an initial access response message on one or more initial access resources, the initial access response message including an identifier associated with the passive UE.

An apparatus for wireless communications at a network entity is described. The apparatus may include at least one processor, and memory coupled (e.g., operatively, communicatively, functionally, electronically, or electrically) to the at least one processor, the memory storing instructions executable by the at least one processor to cause the apparatus to transmit, to a first passive UE, an initial access trigger message including an indication of a first type of passive UE of a set of multiple types of passive UEs and receive, from the first passive UE based on the first passive UE being the first type of UE, an initial access response message on one or more initial access resources, the initial access response message including an identifier associated with the passive UE.

Another apparatus for wireless communications at a network entity is described. The apparatus may include means for transmitting, to a first passive UE, an initial access trigger message including an indication of a first type of passive UE of a set of multiple types of passive UEs and means for receiving, from the first passive UE based on the first passive UE being the first type of UE, an initial access response message on one or more initial access resources, the initial access response message including an identifier associated with the passive UE.

A non-transitory computer-readable medium storing code for wireless communications at a network entity is described. The code may include instructions executable by at least one processor to transmit, to a first passive UE, an initial access trigger message including an indication of a first type of passive UE of a set of multiple types of passive UEs and receive, from the first passive UE based on the first passive UE being the first type of UE, an initial access response message on one or more initial access resources, the initial access response message including an identifier associated with the passive UE.

Some examples of the method, apparatuses, and non-transitory computer-readable medium described herein may further include operations, features, means, or instructions for transmitting, to the first passive UE based on receiving the initial access response message, an initial access acknowledgment message including the identifier associated with the first passive UE and receiving, based on the initial access acknowledgment message, a data message from the first passive UE.

Some examples of the method, apparatuses, and non-transitory computer-readable medium described herein may further include operations, features, means, or instructions for transmitting, to the first passive UE, an indication of a set of multiple candidate muting ratios associated with the first type of passive UE, each muting ratio of the set of multiple candidate muting ratios indicating a respective ratio between a number of initial access response messages and a set of periodic initial access trigger messages including the initial access trigger message, where receiving the initial access response message may be based on transmitting the indication of the set of multiple candidate muting ratios, and where the first type of passive UE may be associated with pre-stored sensor data transmissions of a first priority level and the second type of passive UE may be associated with sensor data transmissions of a second priority level that may be lower than the first priority level.

Some examples of the method, apparatuses, and non-transitory computer-readable medium described herein may further include operations, features, means, or instructions for transmitting, to the first passive UE, a first configuration message indicating a periodicity of a set of multiple access frames associated with the first type of passive UE and a number of available access frames of the set of multiple access frames during a first period, where a first access frame of the set of multiple access frames includes the one or more initial access resources, where the first type of passive UE may be associated with pre-stored sensor data transmissions of a first priority level and the second type of passive UE may be associated with sensor data transmissions of a second priority level that may be higher than the first priority level.

Some examples of the method, apparatuses, and non-transitory computer-readable medium described herein may further include operations, features, means, or instructions for transmitting, to the first passive UE, a second configuration message including an indication of a number of time resources associated with each respective access frame of the set of multiple access frames during the first period, a number of frequency resources associated with each respective access frame of the set of multiple access frames during the first period, or a combination thereof.

Some examples of the method, apparatuses, and non-transitory computer-readable medium described herein may further include operations, features, means, or instructions for detecting a number of collisions during the first period between a set of multiple passive UEs including the first passive UE, a number of idle resources of the number of time resources, the number of frequency resources, or both, or any combination thereof and transmitting, to the set of multiple passive UEs based on the detecting, a third configuration message including an indication of a second number of time resources associated with each respective access frame of the set of multiple access frames during a second period, a second number of frequency resources associated with each respective access frame of the set of multiple access frames during the second period, or a combination thereof.

Some examples of the method, apparatuses, and non-transitory computer-readable medium described herein may further include operations, features, means, or instructions for transmitting, to the first passive UE, an instruction to adjusting a response rate, a muting ratio, or a combination thereof, based on receiving the initial access response message.

Some examples of the method, apparatuses, and non-transitory computer-readable medium described herein may further include operations, features, means, or instructions for transmitting, to the first passive UE based on a failure to receive the initial access response message during a first time period, an instruction to retransmit the initial access response message, where receiving the initial access response message may be based on transmitting the instruction.

Some examples of the method, apparatuses, and non-transitory computer-readable medium described herein may further include operations, features, means, or instructions for including, in the instruction to retransmit the initial access response message, an indication of a subset of retransmission resources of a set of multiple retransmission resources during which the passive UE may be permitted to retransmit the initial access response message, where receiving the initial access response message includes receiving the initial access response message during at least one of the subset of retransmission resources.

Some examples of the method, apparatuses, and non-transitory computer-readable medium described herein may further include operations, features, means, or instructions for transmitting, to the first passive UE, an indication of a supported frequency shift for subcarrier modulation by the first passive UE, where receiving the initial access response message may be based on the indication of the supported frequency shift.

Some examples of the method, apparatuses, and non-transitory computer-readable medium described herein may further include operations, features, means, or instructions for transmitting, to a second passive UE, a second initial access trigger message including an indication of a second type of passive UE of the set of multiple types of passive UEs and receiving, from the second passive UE based on the second passive UE being the second type of UE, a second initial access response message on one or more initial access resources associated with the second type of passive UE, the second initial access response message including an identifier associated with the second passive UE.

### BRIEF DESCRIPTION OF THE DRAWINGS

FIG. 1 illustrates an example of a wireless communications system that supports initial access and device identification protocol design for passive Internet of Things (IoT) in accordance with one or more aspects of the present disclosure.

FIG. 2 illustrates an example of a wireless communications system that supports initial access and device identification protocol design for passive IoT in accordance with one or more aspects of the present disclosure.

FIG. 3 illustrates an example of a wireless communications system that supports initial access and device identification protocol design for passive IoT in accordance with one or more aspects of the present disclosure.

FIG. 4 illustrates an example of a process flow that supports initial access and device identification protocol design for passive IoT in accordance with one or more aspects of the present disclosure.

FIG. 5 illustrates an example of an initial access scheme that supports initial access and device identification protocol design for passive IoT in accordance with one or more aspects of the present disclosure.

FIG. 6 illustrates an example of a timeline that supports initial access and device identification protocol design for passive IoT in accordance with one or more aspects of the present disclosure.

FIGS. 7 and 8 show block diagrams of devices that support initial access and device identification protocol design for passive IoT in accordance with one or more aspects of the present disclosure.

FIG. 9 shows a block diagram of a communications manager that supports initial access and device identification protocol design for passive IoT in accordance with one or more aspects of the present disclosure.

FIG. 10 shows a diagram of a system including a device that supports initial access and device identification protocol design for passive IoT in accordance with one or more aspects of the present disclosure.

FIGS. 11 and 12 show block diagrams of devices that support initial access and device identification protocol design for passive IoT in accordance with one or more aspects of the present disclosure.

FIG. 13 shows a block diagram of a communications manager that supports initial access and device identification protocol design for passive IoT in accordance with one or more aspects of the present disclosure.

FIG. 14 shows a diagram of a system including a device that supports initial access and device identification protocol design for passive IoT in accordance with one or more aspects of the present disclosure.

FIGS. 15 through 20 show flowcharts illustrating methods that support initial access and device identification protocol design for passive IoT in accordance with one or more aspects of the present disclosure.

### DETAILED DESCRIPTION

Wireless communications systems may support communications between passive and active devices, including zero-power passive Internet of Things (IoT) communications. For instance, passive IoT devices may be battery-less, low-end devices with limited transmit/receive capabilities, and may include sensors for inventory management, sensor networking (e.g., factory automation), wearable devices, or the like. Passive IoT devices may be powered by signals sent by a base station, a reader, or other network entity (e.g., by using energy harvesting and backscatter communications by adaptation of antenna load impedance).

Passive IoT devices may thus present different advantages over battery powered devices, such as not requiring a power source, being low-cost, having a small size, being maintenance free, or having a long lifespan, among other examples. For example, user equipments (UE), such as passive user equipments (PUE), may provide (e.g., to a base station or reader) pre-stored data reports (e.g., object identification or inventory management), or may provide real-time sensing data (e.g., safety monitoring or fault detection). Such PUEs may be subject to performance criteria including identification efficiency (e.g., high read rate), or low latency requirements (e.g., for safety data where latency is critical). Techniques for passive IoT devices (e.g., radio frequency identification (RFID) cards) may rely on time-division multiplexing (TDM) techniques with latency delays and low processing capabilities. In some examples, according to techniques for passive IoT devices may PUEs may respond to queries from readers whether they have data to transmit or not, resulting in inefficient use of system resources and increased delays. Thus, some examples of passive IoT communications may result in excessive latency, or may not support processing requirements of PUE procedures in New Radio (NR) systems.

Techniques described herein may support efficient resource utilization in IoT communications networks by configuring a use case dependent initial access control. A network entity (e.g., a base station or reader) may transmit an initial access trigger message (e.g., modulating a continuous wave transmission using amplitude shift keying (ASK)), and the trigger message may include an indication of a type of PUE or a PUE use case (e.g., high priority/latency-critical PUEs or low priority/latency non-critical PUEs). A receiving PUE may ignore triggers for different types of PUEs or PUE use cases, and may respond (e.g., transmit an initial access response message) if the trigger message indicates the PUE's type of PUE or PUE use case. In some examples, for the PUE type or PUE use case associated with latency critical access, the trigger command may be sent periodically, and the PUE may adapt its response rate to the trigger command based on a timing budget to transmit data. In such examples, the PUE may increase its response rate if the PUE has less time left in its timing budget (e.g., may respond to more trigger messages) or may decrease its response rate if the PUE has more time left in its timing budget (e.g., may respond to less trigger messages). In some examples, latency non-critical PUEs, or PUEs of the latency non-critical use case, may be grouped into different frames, slots, and frequency channels to restrict the total number of PUEs to access at the same time. In some examples, a PUE of either type or use case may be muted after a successful response. In some examples, a network entity may schedule retransmissions, where a PUE performing retransmissions may reduce its response rate after each round of retransmission. In some examples, frequencies of a power of 2 relative to a reference frequency may be used for frequency-division multiplexing (FDM) to mitigate harmonic interference.

Aspects of the disclosure are initially described in the context of wireless communications systems. Aspects of the disclosure are further illustrated by and described with reference to wireless communications systems, process flows, initial access schemes, and timelines. Aspects of the disclosure are further illustrated by and described with reference to apparatus diagrams, system diagrams, and flowcharts that relate to initial access and device identification protocol design for passive IoT.

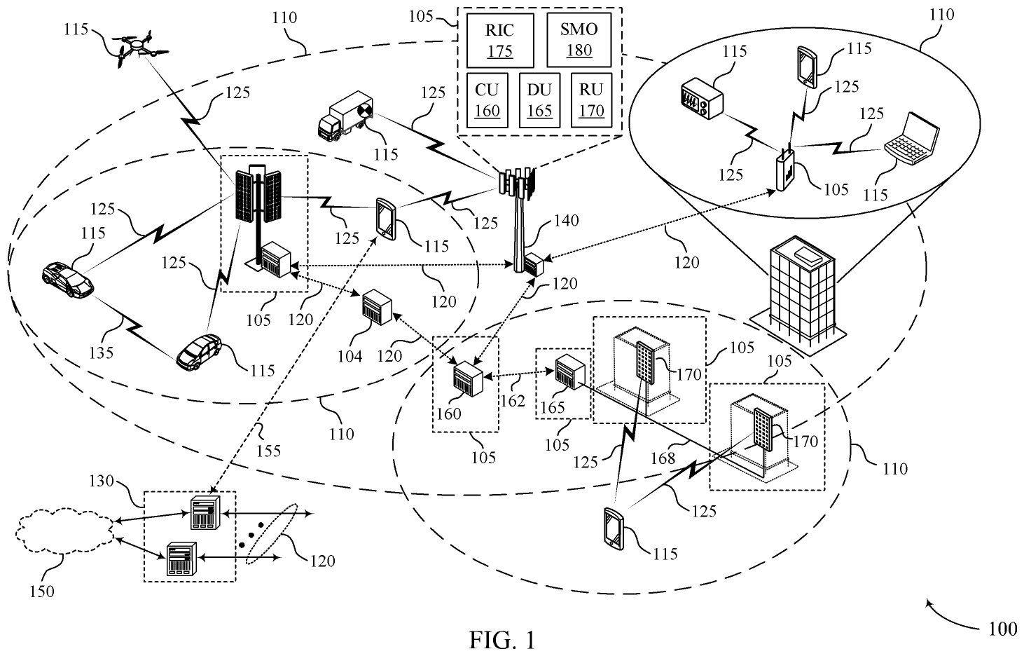

FIG. 1 illustrates an example of a wireless communications system 100 that supports initial access and device identification protocol design for passive IoT in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for transmitting control information to multiple UEs 115 and UE-specific search space sets for transmitting control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

In the case of the techniques described herein applied in the context of a disaggregated RAN architecture, one or more components of the disaggregated RAN architecture may be configured to support initial access and device identification protocol design for passive IoT as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

In some examples, a UE 115 may be an example of a PUE, and may support zero-power passive IoT communications. For example, a PUE 115 may represent an IoT device, which may be a battery-less or battery-assisted (e.g., have a small capacity for energy storage), low-end device with limited transmit/receive capabilities, and may include sensors for inventor management, sensor networking, wearable devices, or the like. In some examples, a PUE 115 may represent any other battery-less or battery-assisted device (e.g., an MTC Wi-Fi, Bluetooth, UWB, or LORA device). In some examples, limited transmit/receive capabilities may include backscatter data transmissions to a network entity 105, as well as simple noncoherent detection in downlink (e.g., envelop detection) for transmissions from a network entity 105. In some examples, a network entity 105 may be an example of a reader. In some examples, a PUE 115 may be powered by signals sent by a reader or other network entity 105 (e.g., by using energy harvesting and backscatter communications by adaptation of antenna load impedance). In some examples, a network entity 105 (e.g., a reader) may power and send transmissions to the PUE 115 using a carrier wave (e.g., a continuous waveform or NR signal). In some instances, the PUE 115-a may operate with ultra-low power consumption (e.g., between 1 micro-Watt (uW) and 1000 uW), which may enable the device to be powered by and process signals sent from the reader or other network entity 105, and which may enable the PUE 115 to respond with backscatter communications. In some examples, the backscatter communications may be modulated (e.g., by varying a signal power (e.g., voltage or other characteristic) between a low power ‘logic 0’ and a high power ‘logic 1’).

In some examples, passive IoT devices may present different advantages over battery powered devices, such as not requiring a power source, being low-cost or ultra-low-cost, having a small size, being maintenance free, having a long lifespan, or other benefits. For example, a PUE 115 may provide (e.g., to a reader or other network entity 105) pre-stored data reports, which may be used for objects identification or inventory management (e.g., in smart logistics/warehousing). By way of another example, a PUE 115 may provide (e.g., to a reader or other network entity 105) real-time sensing data for wireless sensor networking, such as safety monitoring or fault detection data (e.g., for factory automation). Such PUEs 115 may be subject to performance criteria including identification efficiency (e.g., high read rate), or low latency requirements (e.g., for safety data where latency is critical). Techniques for PUEs 115 (e.g., radio frequency identification (RFID) cards) may rely on time-division multiplexing (TDM) techniques with latency delays, low processing capabilities, and may further rely on the PUEs 115 responding to queries whether they have data to transmit or not, resulting in inefficiency. Thus, some techniques may result in excessive latency, or may not support processing requirements of PUE procedures in NR. In some examples, FDM may be used in passive IoT systems and may cause harmonic interference, which may result in additional inefficiencies. Techniques described herein may include a hybrid anti-collision protocol combining TDMA and FDMA, which may be used to increase efficient use of resources for mitigating transmission collisions.

In some examples, the wireless communications system 100 may support techniques for efficient resource utilization in IoT communications networks by configuring a use case dependent initial access control. For example, a network entity 105 (e.g., a base station or reader) may transmit an initial access trigger message (e.g., modulating a continuous wave transmission using ASK via a communication link 125), and the trigger message may include an indication of a type of PUE or a PUE use case (e.g., high priority/latency-critical PUEs or low priority/latency non-critical PUEs). A receiving PUE 115 may harvest energy from the initial access trigger message for transmitting an initial access response message including an identifier for the receiving PUE 115 and a data message. The receiving PUE 115 may transmit the initial access response message (e.g., on one or more initial access resources associated with the communication link 125) using the harvested energy if the trigger message indicates the PUE type or PUE use case of the PUE 115. In some examples, the receiving PUE 115 may ignore triggers for different types of PUEs or PUE use cases. In some examples, frequencies of a power of 2 relative to a reference frequency may be used for frequency-division multiplexing (FDM) to mitigate harmonic interference.

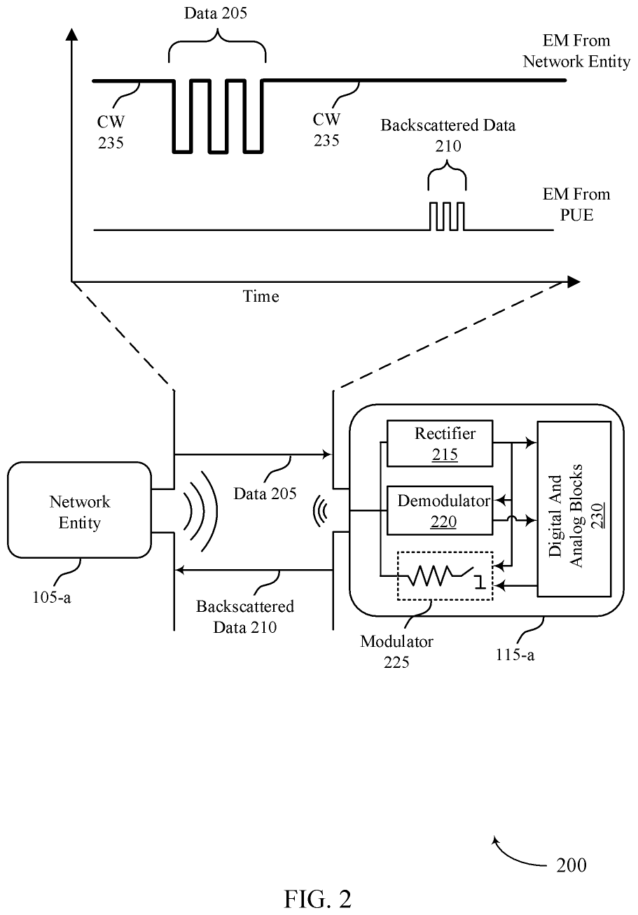

FIG. 2 illustrates an example of a wireless communications system 200 that supports initial access and device identification protocol design for passive IoT in accordance with one or more aspects of the present disclosure. In some examples, the wireless communications system 200 may implement, or be implemented by, aspects of the wireless communications system 100. The wireless communications system 200 may include a network entity 105-a and a PUE 115-a, which may be examples of the network entities 105 (e.g., a base station or reader) and the UEs 115 or PUEs 115 described with reference to FIG. 1. In some examples, the PUE 115-a may be an example of a battery-less or battery-assisted PUE (e.g., a passive RFID device, a tag, a UE, a low capacity UE, a low-power UE, or any other type of wireless device or network node) as described herein. In some examples, the network entity 105-a may represent an aspect of a base station or disaggregated base station, a functionality of a base station (e.g., a CU functionality, a DU functionality), or a reader (e.g., an RFID reader). The PUE 115 may further include a rectifier 215, a demodulator 220, a modulator 225, and digital and analog blocks 230. The network entity 105-a and the PUE 115-a may also exchange data 205 and backscattered data 210 using electromagnetic (EM) communications.

In some examples, the techniques described herein in reference to the PUE 115-a may be implemented by any type of UE (e.g., a UE, a smart device, a wearable device, a PUE, or a low capacity UE). Similarly, the techniques described herein in reference to the network entity 105-a may also be implemented by any type of network entity (e.g., a network entity, a reader, a CU, a DU, an RU, an RIC, or an SMO).

In some examples, the network entity 105-a may transmit (e.g., in downlink), a continuous waveform (CW) signal 235 to the PUE 115-a including the data 205. For example, the network entity 105-a may modulate or otherwise alter the CW signal 235 to convey the data 205. In such examples, the CW signal 235 may act as a carrier wave for the data 205. In some instances, the data 205 may include a trigger (e.g., an interrogate command), and the PUE 115-a may respond to the trigger. The data 205 may additionally include any other type of data.

In some examples, the PUE 115-a may harvest energy from the CW signal 235 for transmitting messages back to the network entity 105-a (e.g., the network entity 105-a may provide power to the PUE 115-a via the CW signal 235). For example, the PUE 115-a may employ various methods to convert the EM power transmitted in the CW signal 235 into a different medium (e.g., into a continuous voltage). In some examples, this power conversion process may be done using the rectifier 215. The PUE 115-a may thus use the EM energy transmitted in the CW signal 235 to power on and perform different functions (e.g., processing data, sending new transmissions, among other examples).

The PUE 115-a may utilize the harvested energy from the CW signal 235 to modulate and transmit the backscattered data 210. For example, the PUE 115-a may demodulate the data 205 carried in the CW signal 235 using the demodulator 220 (e.g., using a simple noncoherent detection). In some examples, the digital and analog blocks 230 may use the harvested energy (e.g., received via the rectifier 215) to process the demodulated data (e.g., received from the demodulator 220) and generate outgoing data for modulation at the modulator 225. The PUE may thus modulate the outgoing data using the modulator 225 to create the backscattered data 210, and transmit the backscattered data 210 using the harvested energy. In some examples, the PUE 115-a may modulate the outgoing data to create the backscattered data 210 by varying the input impedance of the PUE 115-a (e.g., by varying between a conjugate match and a strong mismatch). In some instances, the PUE 115-a and its components may operate with ultra-low power consumption (e.g., between 1 micro-Watt (uW) and 1000 uW), enabling modulating and transmitting the backscattered data 210 with the amount of harvested energy from the CW signal 235. In some examples, the PUE 115-a may first receive the data 205, and (e.g., after harvesting energy from and modulating the data 205) may subsequently transmit the backscattered data 210. In some examples, the communications between the network entity 105-a and the PUE 115-a is half-duplex, and the PUE 115-a may not demodulate the data 205 while backscattering.

In some examples, the network entity 105-a and the PUE 115-a may support short-range communication. For example, the exchange of the data 205 and the backscattered data 210 described herein may take place in a short physical range (e.g., in a range less than 10 meters). In some examples, the PUE 115-a may support transmission of the backscattered data 210 within a predefined range (e.g., may be limited by the power harvested from the CW signal 235).

In some examples, the backscatter communications described with reference to wireless communications system 200 may support a query-response protocol (e.g., in a Interrogator-Talks-First (ITF) RFID system such as EPC Class 1 Gen-2). For example, the network entity 105-a (e.g., a reader) may issue a first command (e.g., a QUERY command) by transmitting a first message including the first command via the data 205 and the CW signal 235 to one or more PUEs 115.

In some examples, each PUE 115 may respond to the first command depending on a randomly selected (e.g., rolled) slot number. For example, the PUE 115-a, in response to the first command in the data 205, may roll a randomized slot number. In some examples, if the slot number rolled is a 0, the PUE 115-a may transmit the backscattered data 210 within a current slot (e.g., immediately) to the network entity 105-a. In some examples, after rolling the slot number as 0, the PUE 115-a may generate and include a random number (e.g., a 16-bit random number) in the backscattered data 210. In some examples, if the slot number rolled is not a 0, the PUE 115-a may record the slot number rolled in a memory (e.g., a counter) and refrain from replying to the trigger. In some examples, the PUEs 115 may not respond unless directed to by the network entity 105-a as described herein.

If the network entity 105-a receives a response from the PUE 115-a, the network entity 105 may acknowledge to the PUE 115-a that the response was received. For example, the network entity 105-a may respond to receiving the generated random number from the PUE 115-a by transmitting the same random number back to the PUE 115-a (e.g., as an acknowledgment (ACK) of the received response). If the number sent by the network entity 105-a to the PUE 115-a matches the random number generated at the PUE 115-a, the PUE 115-a may begin to transmit data back to the network entity 105-a (e.g., by transmitting backscatter data 210 based on receiving the ACK from the network entity 105-a via data 205). In some examples, the PUE 115-a may not begin to transmit data if the number sent by the network entity 105-a does not match the random number generated at the PUE 115-a (e.g., the other PUEs 115 may receive the number generated at the PUE 115-a and may ignore the command).

In some examples, (e.g., if the network entity 105-a does not receive a response to the initial command), the network entity 105-a may issue an instruction to decrement a count by 1. For example, if the network entity 105-a does not receive a 16-bit random number (e.g., within a time frame in response to the initial command), the network entity 105-a may transmit the instruction (e.g., a QUERY REP or Next Slot command) to the PUE 115-a as well as to the multiple other PUEs 115 within range. In response to the instruction, the PUE 115-a may decrement its respective recorded random slot number by 1. If the slot number is at 0 after decrementing by 1, the PUE 115-a may respond to the command as described herein (e.g., may transmit a random number to the network entity 105-b). In some examples, the other PUEs 115 may also decrement their respective recorded slot numbers by 1 and respond if their respective recorded slot numbers reach 0. In some examples, the network entity 105-a may issue additional instructions to decrement the count if the network entity 105-a does not receive responses from the PUEs 115, and the PUEs 115 may continue to decrement in response to the instructions until one of the PUEs 115 reaches 0. In some examples, the network entity 105-a may employ anti-collision schemes (e.g., slotted-ALOHA) to identify a PUE 115 if multiple PUEs 115 respond at the same time.

In some examples, the operations described herein may be used for object identification and pre-stored data reports. For example, one or more PUEs 115 (e.g., including the PUE 115-a) may support object identification by transmitting pre-stored data reports (e.g., when triggered by the network entity 105-a). By way of another example, pre-stored data reports may be used for inventory management (e.g., in smart logistics/warehousing). In such examples, the PUE 115-a may generate pre-stored data reports (e.g., indicating the location or presence of one or more objects), and may transmit the pre-stored data reports upon receiving a trigger (e.g., via the data 205) from the network entity. In some examples, the communications system 200 may satisfy performance criteria for initial access such as identification efficiency (e.g., a high read rate, such as a read rate up to 1200 unique 96-bit tags per second).

Additionally, or alternatively, the operations described herein may support real-time sensing data transmissions. For instance, the wireless communications system 200 may support factory automation, one or more sensors or actuators, or other deployments. In such examples, the PUE 115-a may include or be connected to one or more sensors, and may report sensor information to the network entity 105-a (e.g., for safety monitoring, fault detection, or other factory automation processes). In some cases, the PUE 115-a may have limited memory and may be able to store a limited amount of data. However, the PUE 115-a may generate time-sensitive information, and in some cases sensor data may be lost if the PUE 115-a does not transmit the sensor data before receiving or generating additional sensor data (e.g., before additional data transmissions arrive). Thus, the wireless communications system 200 may support techniques for initial access that satisfy the time-sensitive latency requirements of real-time sensing, and any criteria for object identification (e.g., reading rates, latency, or the like) to prevent loss of data, collisions, failed transmissions, or to maintain a safe environment.

In some cases, the wireless communications system 200 (e.g., an IoT system) may co-exist with NR and TDD frame structure. In some examples, IoT communication resources may be limited. However, techniques described herein may support communications between a large number of devices. In some examples, limited resources may prevent the network entity 105-a (e.g., a gNB or reader) from continuously transmitting or receiving from the PUE 115-a and other PUEs 115. This may cause delayed transmissions (e.g., in the case of large bit tags) and an increase in collisions of transmissions, which may result in inefficient communications as well as dangerous conditions.

In some examples, multi-PUE collisions may be resolved by using the query-response protocol described herein (e.g., based on slotted-ALOHA). In some examples, all PUEs 115 operating according to the query response protocol may respond using the same frequency. However, for passive IoT, multiple frequency channels may be supported for backscatter link communications, and some query-response protocols may result in inefficient use of resources.

In some examples, a reading delay from limited resources may be due to a number of PUEs 115. For example, to achieve higher efficiency, the wireless communications system 200 may adjust a number of slots or resources available according to the number of PUEs 115 (e.g., ALOHA protocol may rely on increasing a number of resources to be assigned according to a number of tags). In some cases, this may be mitigated with an estimation function to estimate the number of PUEs 115 (e.g., via observations, such as idle slot, collision slot, successful slot quantity in last inventory round). However, such an estimation function may be based on an assumption that a quantity of PUEs 115 does not suddenly increase or decrease in a time frame.

In some examples, the wireless communications system 200 may support (e.g., for latency critical initial access) a restriction of a number of tags permitted to transmit at the same time. In some examples, transmissions (e.g., and user pre-selection) may be based on an identifier match. In such examples, selected PUEs 115 may not have any new data for transmission, but may still be expected to respond to a trigger, which may result in an unnecessary use of resources.

In some examples, FDM used for initial access in the wireless communications system 200 (e.g., for RFID backscatter modulation using a subcarrier modulated FSK scheme in the operations described herein) may result in sideband harmonic interference. For example, the PUE 115-a may modulate its antenna impedance by switching with a square wave operating at a chosen frequency (e.g., Δf), thus shifting the baseband frequency by Δf relative to the carrier frequency of the CW signal 235. In some examples, subcarrier modulation based on a square wave may generate sideband harmonic interference. For example, a square wave at a rate of Δf may be written as a sum of cosine waves

$$( e . g . , Square ( Δ f t ) = \frac{4}{π} {\sum }_{n = 0}^{∞} \frac{1}{2 n + 1} cos ( 2 π ( 2 n + 1 ) Δ f t ) ) .$$

Such sideband harmonic interference may result in additional collisions between signals, lowered signal power, and other inefficient results.

As described herein, efficient resource utilization in IoT communication networks using backscatter modulation may be enabled by configuring a use case or device type dependent initial access control. The network entity 105-a (e.g., a base station or reader) may transmit an initial access trigger message (e.g., modulating a continuous wave transmission using ASK), and the trigger message may include an indication of a type of PUE 115 or a PUE 115 use case (e.g., high priority/latency-critical PUEs 115 or low priority/latency non-critical PUEs 115). The receiving PUE 115-a may ignore triggers for different types of PUEs, and may respond (e.g., transmit an initial access response message) if the trigger message indicates the PUE type of the receiving PUE 115-a. In some examples, the PUE 115-a may receive a trigger, and the trigger may indicate a use case. The PUE 115-a may respond to the trigger according to the use case (e.g., or may respond if the indicated use case is applicable to a current use case of the PUE 115-a).

In some examples, if the PUE 115-a is of the PUE type or first PUE use case (e.g., for latency critical initial access), the trigger command may be sent periodically, and the PUE 115-a may adapt its response rate to the trigger command based on a timing budget to transmit data. In such examples, the PUE 115-a may increase its response rate if the PUE 115-a has less time left in its timing budget (e.g., may respond to more trigger messages) or may decrease its response rate if the PUE 115-a has more time left in its timing budget (e.g., may respond to less trigger messages). In some examples, the PUE 115-a may be a second type of PUE 115 or may operate according to a second use case (e.g., a latency non-critical PUE), and may be grouped with other PUEs 115 of the same type or operating according to the second use case, into different frames, slots, and frequency channels to restrict the total number of PUEs to attempt initial access at the same time. In some examples, the PUE 115-a may be muted after a successful response for either PUE type or PUE use case. Alternatively, the network entity 105-a may schedule retransmissions, where a PUE performing retransmissions (e.g., the PUE 115-a) may reduce its response rate after each round of retransmission. In some examples, frequencies of a power of 2 relative to a reference frequency may be used for frequency-division multiplexing (FDM) to mitigate harmonic interference. The operations described herein may support greater efficiency in operations, faster and more reliable communications, (e.g., with better latency) and faster object identification (e.g., even for large bit tags).

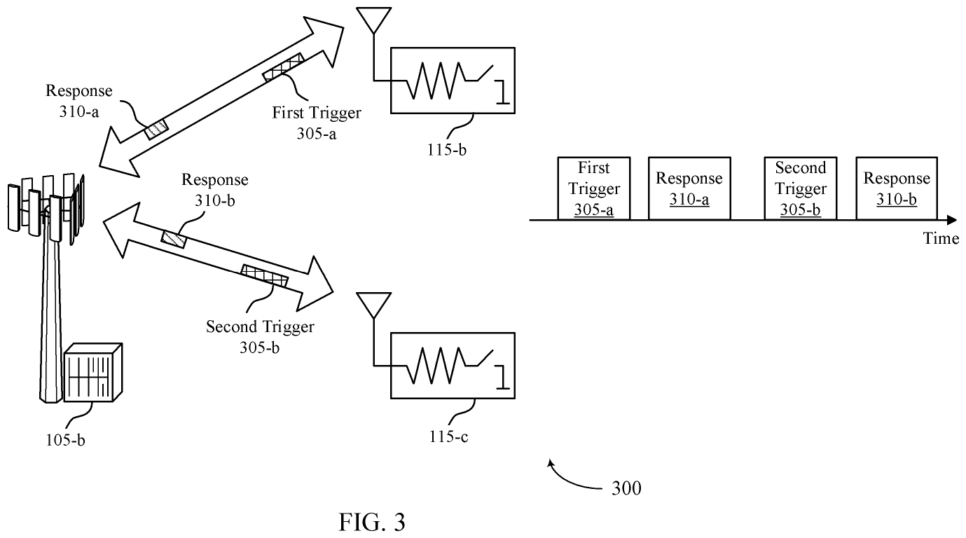

FIG. 3 illustrates an example of a wireless communications system 300 that supports initial access and device identification protocol design for passive IoT in accordance with one or more aspects of the present disclosure. In some examples, the wireless communications system 300 may implement, or be implemented by, aspects of the wireless communications system 100 and the wireless communications system 200. The wireless communications system 300 may include a network entity 105-b, a PUE 115-b, and a PUE 115-c, which may be examples of the network entity 105-a and the PUE 115-a as described with reference to FIG. 2. In some examples, the PUE 115-b and the PUE 115-c may support communication with the network entity 105-b using backscatter communications as described with reference to FIG. 2. In some examples, the network entity 105-b may communicate with one or more other PUEs 115, or one or more other network entities 105. In some examples, the PUEs 115 and the network entity 105-b may be part of a passive IoT system. Although techniques described herein are performed by PUEs 115, similarly techniques may be performed by any wireless device (e.g., UE 115).

As described herein, the PUE 115-a and the PUE 115-b may be different types of PUEs 115, or may be the same type of PUE but may operate according to different use cases. For example, the PUE 115-b may operate according to a first use case for lower priority, latency non-critical communications and may transmit pre-stored data to the network entity 105-b. The second PUE 115-c may operate according to a second use case for higher priority, latency critical communications and may transmit critical sensor data to the network entity 105-b. In some examples, the network entity 105-b may configure the PUEs 115 to operate according to either use case. In some examples, the PUE 115-b and the PUE 115-c may represent examples of two different types of PUEs 115. For example, the PUE 115-b may represent a first PUE type that supports lower priority, latency non-critical communications (e.g., pre-stored data transmission), and the PUE 115-c may represent a second PUE type that supports higher priority, latency critical communications (e.g., sensor data transmission). In some examples, the PUEs 115 may respond to triggers 305 based at least in part on respective PUE types, or use cases.

In some examples, as described herein, the PUE 115-b may operate according to the first use case (e.g., latency non-critical communications), and the PUE 115-c may operate according to the second use case (e.g., latency critical communications). In such examples, the network entity 105-b may configure separate initial access resources for the two use cases. For example, the triggers 305 may differentiate the separate initial access resources via a type indicator (e.g., a 1-bit type indicator) in each triggering command indicating a specific use case. In some examples, the network entity 105-b may use the indicators in the triggers 305 as selection criteria for selecting PUEs of either the first use case or the second use case for response. (e.g., the PUE 115-b or the PUE 115-c may respond if the trigger matches its use case).

In some examples, the network entity 105-b may transmit a first trigger 305-a to the PUE 115-b that operates according to the first use case. The first trigger 305-a may include a type indicator (e.g., a 1-bit type indicator) that may indicate the first use case. The PUE 115-b may determine that the first trigger 305-a applies to the PUE 115-b based on the type indicator. In some examples, the PUE 115-b and the PUE 115-c may both be enabled to decode the first trigger 305-a (e.g., PUEs for both use cases may be configured to decode triggers with indicators for either use case). In such examples, the PUE 115-b may respond to the first trigger 305-a (e.g., in the corresponding resources associated with the first use case), while the PUE 115-c may ignore the first trigger 305-a (e.g., may refrain from responding to the first trigger 305-a).

The PUE 115-b may transmit a response 310-a to the network entity 105-b. For example, the PUE 115-b may decode the first trigger 305-a and may transmit the response 310-a on a first set of resources corresponding to the first use case (e.g., by modulating and transmitting backscatter communications on the indicated resources). In some examples, the PUE 115-b may not respond (e.g., may not transmit a response 310-a in the resources associated with the first use case) if the first trigger 305-a does not match the first use case (e.g., the indicator may indicate a use case that is different from the use case of the PUE 115-b). In some examples, the PUE 115-c may also receive and decode the first trigger 305-a. In some cases, the PUE 115-c may be operate according to a use case different from the first use case, and may ignore the first trigger 305-a.

Additionally, or alternatively, the network entity 105-b may transmit a second trigger 305-b to the PUE 115-c that operates according to the second use case. The second trigger 305-b may include a type indicator (e.g., a 1-bit type indicator) that may indicate the second use case. In some examples, the PUE 115-b and the PUE 115-c may both be enabled to decode the second trigger 305-b (e.g., PUEs for both use cases may be configured to decode triggers with indicators for either use case).

In some examples, the PUE 115-c may transmit a response 310-b to the network entity 105-b. For example, the PUE 115-c may decode the second trigger 305-b and transmit the response 310-b on a second set of resources corresponding to the second use case. In some examples, the PUE 115-c may not respond (e.g., may not transmit a response 310-b) if the second trigger 305-b does not match the second use case (e.g., the indicator may indicate a use case that is different from the use case of the PUE 115-c). In some examples, the PUE 115-b may also receive and decode the second trigger 305-b. In some cases, the PUE 115-b may not respond accordingly (e.g., the indicator in the second trigger 305-b may indicate the second use case and not the first use case according to which the PUE 115-b operates).

In some examples, as described herein, a wireless communications system may support two types of defined UEs (e.g., two types of PUEs 115). The PUE 115-b may be a first type of PUE (e.g., a latency non-critical PUE), and the PUE 115-c may be a second type of PUE (e.g., a latency critical PUE). In some examples, the network entity 105-b may use the triggers 305 to select a specific type of PUE 115 (e.g., the first PUE type or the second PUE type). In some examples, the triggers 305 may differentiate separate initial access resources for each PUE type via a type indicator (e.g., a 1-bit type indicator) in each triggering command indicating the specific PUE type (e.g., the first PUE type or the second PUE type). Additionally, or alternatively, the selection may be made by transmitting different types of triggers depending on the PUE type (e.g., a first trigger type may correspond to the first PUE type, and a second trigger type may correspond to the second PUE type).

In some examples, the network entity 105-b may transmit the first trigger 305-a to the PUE 115-b of the first PUE type. In some examples, the first trigger 305-a may include a type indicator (e.g., a 1-bit type indicator) that may indicate the first PUE type. Additionally, or alternatively, the first trigger 305-a may be the first trigger type corresponding to the first PUE type (e.g., the PUE 115-b may attempt to decode the first trigger 305-a, and may determine whether the type, formatting, or defined indicator of the trigger 305-a matches the first PUE type). In some examples, the PUE 115-b and the PUE 115-c may both be enabled to decode the first trigger 305-a (e.g., PUEs for both PUE types may be configured to decode triggers including indictors for or of a trigger type for either PUE type). In such examples, the PUE 115-c (e.g., which may be the second PUE type may receive the first trigger 305-a, but may ignore the first trigger 305-a because the first trigger 305-a does not correspond to the second PUE type).

The PUE 115-b may transmit the response 310-a to the network entity 105-b (e.g., via resources allocated for the first PUE type). For example, 305-a. the PUE 115-b may decode the first trigger 305-a and transmit the response 310-a on a set of resources (e.g., by modulating and transmitting backscatter communications on the indicated resources). In some examples, the PUE 115-b may transmit the response 310-a on a set of resources associated with the first PUE type. In some examples, the PUE 115-b may not respond (e.g., may not transmit the response 310-a) if the first trigger 305-a does not match the first PUE type (e.g., the indicator may indicate a PUE type that is different from the PUE type of the PUE 115-b, or the first trigger 305-a may not be the trigger type corresponding to the PUE type of the PUE 115-b). In some examples, the PUE 115-c may also receive and decode the first trigger 305-a. In some cases, the trigger 305-a may not match the PUE type of the PUE 115-c, and the PUE 115-c may refrain from responding accordingly.

Additionally, or alternatively, the network entity 105-b may transmit the second trigger 305-b to the PUE 115-c of the second PUE type. In some examples, the second trigger 305-b may include a type indicator that may indicate the second PUE type. Additionally, or alternatively, the second trigger 305-b may be the second trigger type corresponding to the second PUE type (e.g., the PUE 115-b may attempt to decode the second trigger 305-b, and may determine whether the type, formatting, or defined indicator of the trigger 305-b matches the second PUE type). In some examples, the PUE 115-b and the PUE 115-c may both be enabled to decode the second trigger 305-b (e.g., PUEs for both PUE types may be configured to decode triggers including indictors for or of a trigger type for either PUE type). In such examples, the PUE 115-b (e.g., which may be the first PUE type may receive the second trigger 305-b, but may ignore the second trigger 305-b because the second trigger 305-b does not correspond to the first PUE type).

In some examples, the PUE 115-c may transmit the response 310-b to the network entity 105-b (e.g., via resource allocated for the second PUE type). For example, the PUE 115-c may decode the data in the second trigger 305-b and transmit the response 310-b on a set of resources (e.g., by modulating and transmitting backscatter communications on the indicated resources). In some examples, the PUE 115-c may transmit the response 310-b on a set of resources associated with the second PUE type. In some examples, the PUE 115-c may not respond (e.g., may not transmit the response 310-b) if the second trigger 305-b does not match the second PUE type (e.g., the indicator may indicate a PUE type that is different from the PUE type of the PUE 115-c, or the second trigger 305-b may not be the trigger type corresponding to the PUE type of the PUE 115-c). In some examples, the PUE 115-b may also receive and decode the second trigger 305-b. In some cases, the trigger 305-b may not match the PUE type of the PUE 115-b, and the PUE 115-b may refrain from responding accordingly.

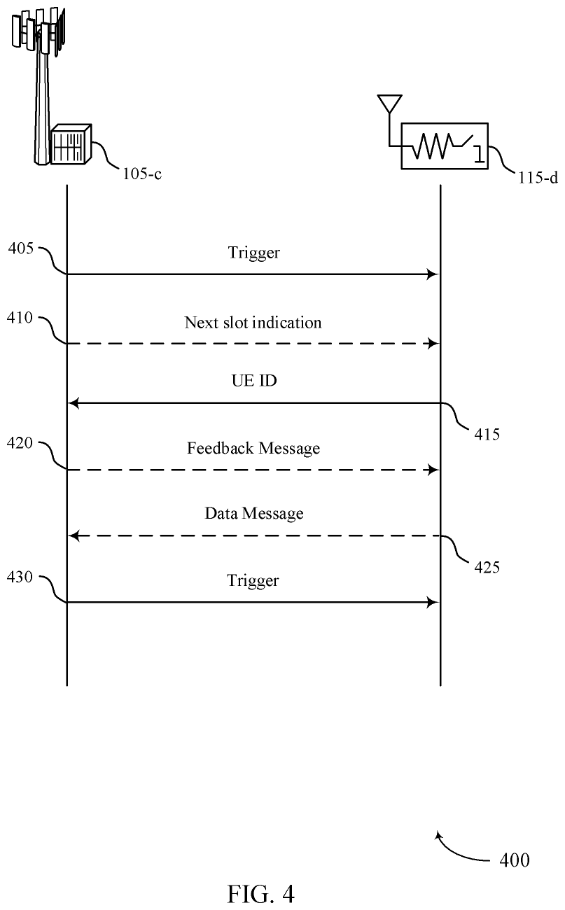

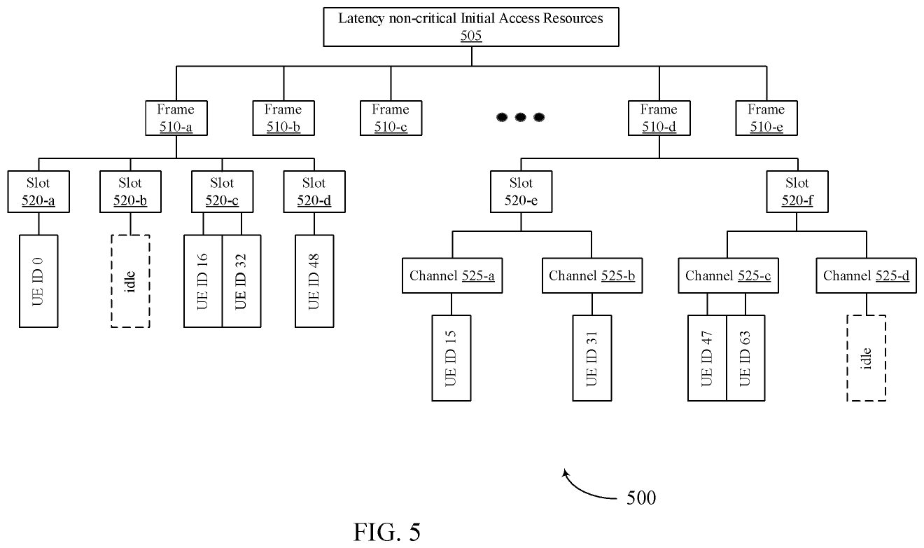

In some examples, the above operations may be done in a different order, at the same time, at different times, or in any other order or configuration. In some examples, PUEs that operate according to the first PUE use case or of the first PUE type (e.g., the PUE 115-b) may be further grouped into different frames, slots, and frequency channels, as described in further detail with reference to FIG. 5. Additionally, or alternatively, trigger commands including indicators for the second PUE use case or the second PUE type, or of the second trigger type, (e.g., the second trigger 305-b) may be sent periodically, and PUEs configured for the second PUE use case or of the second PUE type (e.g., the PUE 115-c) may adapt their response rate to the trigger commands based on a timing budget to transmit data, as described in further detail with reference to FIG. 4.

FIG. 4 illustrates an example of a process flow 400 that supports initial access and device identification protocol design for passive IoT in accordance with one or more aspects of the present disclosure. In some examples, the process flow 400 may implement, or be implemented by, aspects of the wireless communications systems 100, 200, or 300. In particular, the process flow 400 illustrates configurations and signaling which may enable a PUE 115-d (e.g., of the second PUE type or PUE use case associated with latency critical access) to adapt its response rate to trigger commands sent by a network entity 105-c based on a timing budget to transmit data.

The process flow 400 may include a PUE 115-d and a network entity 105-c, which may be examples of the UEs 115 or the PUEs 115 and the network entities 105 as described with reference to FIGS. 1-3. For example, the PUE 115-d may represent an example of the PUE 115-c, as described with reference to FIG. 3, where the PUE 115-d may operate according to a pre-defined use case or may be a pre-defined type of UE (e.g., the second, latency critical PUE type or use case as described with reference to FIG. 3). In some examples, the PUE 115-d may be, and the operations described herein may be performed by, any other type of UE (e.g., a latency non-critical PUE, a UE, a smart device, a wearable device, or a low capacity UE). Similarly, the network entity 105-c may represent an example of the network entity 105-b as described with reference to FIG. 3. In some examples, the network entity 105-c may represent an example of any type of network entity (e.g., a network entity, an RFID reader, a CU, a DU, an RU, an RIC, or an SMO).

In the following description of the process flow 400, the operations between the PUE 115-d and the network entity 105-c may be transmitted in a different order than the order shown, or the operations performed by network entity 105-c and the PUE 115-d may be performed in different orders or at different times. Some operations may be omitted from the process flow 400, or other operations may be added to the process flow 400. While the network entity 105-c and the PUE 115-d are shown performing a number of the operations of process flow 400, any wireless device may perform the operations shown.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 405, the network entity 105-c may transmit, and the PUE 115-d may receive, a first initial access trigger message (e.g., including an indication of a use case of multiple use cases or an indication of a type of PUE of multiple types of PUEs such as the second, latency critical use case or PUE type as described herein with reference to FIGS. 1-3). In some examples, the network entity 105-c may transmit the first trigger command periodically (e.g., may repeatedly and periodically transmit the trigger command, such as transmitting a trigger command at 405, as well as at 430, and periodically thereafter). In some examples, the first trigger may include an indication of a set of slot numbers (e.g., a threshold or maximum number of slots K).

In some examples, the PUE 115-d may select one or more initial access resources based on the PUE 115-d operating according to the use case or being the type of PUE indicated in the first trigger command (e.g., may select resources configured for the PUE 115-d's use case or type of PUE). For example, the network entity 105-c may configure separate initial access resources for the multiple use cases or for the multiple types of PUEs, including one or more initial access resources for the use case or the type of PUE. In some examples, the first trigger may differentiate the separate initial access resources via the indication (e.g., a 1-bit type indicator) of the use case or the type of PUE. In some examples, the

At 415, the PUE 115-d may transmit, and the network entity 105-c may receive, an initial access response message including an identifier (e.g., ID) for the PUE 115-d (e.g., a random number indicating a temporary UE ID). In some examples, the PUE 115-d may transmit the initial access response message on the selected one or more initial access resources.

In some examples, the PUE 115-d may adapt its response rate to the periodic triggers based at least in part on an available timing budget for transmitting available data. For example, the PUE 115-d may generate high priority or time sensitive data for transmission. Such data may include safety related sensor data, identification of safety protocols or breaches, malfunctioning equipment, broken or damaged aspects of a factory deployment, or the like. In some examples, the PUE 115-d may have a limited storage capacity or memory, and the sensor data may be lost, overwritten, or deleted, if the PUE 115-d does not transmit the sensor data within a timing budget. In some examples, the data may be low latency communications (e.g., URLLC communication) or may be otherwise subject to low latency constraints.

The system may function at improved capacity and efficiency if the PUE 115-d can reliably transmit the sensor data to the network entity 105-c. Thus, if a timing budget is smaller (e.g., if there is less time remaining to transmit the data) then the PUE 115-d may transmit the data according to a smaller muting ratio (e.g., may respond to periodic triggers more often). If the timing budget is larger (e.g., if there is more time remaining to transmit the data) then the PUE 115-d may transmit the data according to a larger muting ratio (e.g., may respond to periodic triggers less often). The PUE 115-d may transmit the initial access response message according to a muting ratio corresponding to the use case or the type of PUE indicated in the first trigger. In some examples, the use case or the type of PUE may be associated with high priority sensor data (e.g., critical sensor data associated with the second, latency critical use case or PUE type as described with reference to FIG. 3). In some examples, a different use case or type of PUE may be associated with lower priority sensor data transmissions.

In some examples, the PUE 115-d may select the muting ratio from a set of multiple candidate muting ratios (e.g., preconfigured or previously-configured muting ratios, including unmuted, 1/2, 3/4, 21/32, or 511/512). For instance, if the PUE 115-d selects a 1/2 muting ratio, then the PUE 115-d may respond to half of received periodic triggers (e.g., may transmit a response message at 415 in response to the trigger received at 405, but may refrain from transmitting a response message to a trigger received at 430). In some examples, the network entity 105-c may transmit control signaling (e.g., RRC signaling, a DCI message, a MAC-CE, or the like) indicating a single muting ratio, a set of muting ratios, or a subset of previously configured or preconfigured (e.g., standardized) candidate ratios. In some examples, each muting ratio of the set of multiple muting ratios may indicate a respective ratio between a number of initial access response messages and a set of periodic initial access trigger messages, including the first initial access trigger message sent from the network entity 105-c. In some examples, the muting ratio may be based on an amount of time in a timing budget for transmitting a data message (e.g., the muting ratio may be based on an amount of time left to transmit data before data is lost or before low latency constraints are satisfied). If there is less time remaining, the PUE 115-d may select a smaller muting ratio, or a higher response rate). In some examples, the network entity 105-c may transmit, and the PUE 115-d may receive, an indication of the set of multiple candidate muting ratios (e.g., in the first trigger, or in a separate message). In some examples, the network entity 105-c may assign a specific muting ratio to the PUE 115-d. In some examples, the PUE 115-d may determine whether to respond to the first trigger sent from the network entity 105-c based on the muting ratio (e.g., may determine whether or not to transmit the initial access response message at 415.

In some examples, the PUE 115-d may transmit the initial access response message according to a selected slot number. The PUE 115-d may select a slot (e.g., from the threshold number of slots K indicated in the trigger command) based on the selected muting ratio. For example, if the PUE 115-d determines not to respond to the trigger received at 405 (e.g., according to a selected muting pattern), the PUE 115-d may generate a slot number equal to infinity. In such examples, (e.g., even if the PUE 115-d receives a next slot indication or instruction to decrement a counter, the PUE 115-d will merely decrement the slot number from infinity, and will not transmit a response message at 415). In some examples, if the PUE 115-d determines to respond to the trigger received at 405, the PUE 115-d may randomly roll a slot number (e.g., as described with reference to FIG. 2). In some examples, the PUE 115-d may refrain from responding until the slot number satisfies a condition (e.g., until the slot number equals zero). For example, the network entity 105-c may transmit a next slot indication at 410, which may indicate to decrement the slot number by 1. The PUE 115-d, after generating the slot number, may decrement the slot number by 1 based on the next slot indication, and may transmit a response message (e.g., the UE ID) at 415 upon decrementing the slot number to 0 (e.g., if the PUE 115-d has determined to transmit a response according to the selected muting ratio).

At 420, the network entity 105-c may transmit, and the PUE 115-d may receive, an initial access acknowledgment message (e.g., feedback, such as an ACK or other feedback message) including the identifier for the PUE 115-d. In some examples, the network entity 105-c may transmit the initial access acknowledgment message in response to receiving the initial access response message at 415.

At 425, the PUE 115-d may transmit, and the network entity 105-c may receive, a data message. In some examples, the PUE 115-d may transmit the data message based on (e.g., in response to) receiving the initial access acknowledgment message. In some examples, the data message may include high priority sensor data (e.g., critical sensor data associated with the second, latency critical use case or PUE type as described with reference to FIG. 3).

At 430, the network entity 105-c may transmit, and the PUE 115-d may receive, a second initial access trigger message (e.g., a periodic trigger transmitted at 405 and at 430). In some examples, the second trigger at 430 may include a second indication of the first use case or of the first type of PUE. In some examples, the PUE 115-d may respond by transmitting a second initial access response message according to the selected muting ratio (e.g., a higher response rate). In some examples, the PUE 115-d may refrain from responding by transmitting a second initial access response message based on transmitting the UE ID at 415, according to the selected muting ratio (e.g., a lower response rate). In some examples, the PUE 115-d may not respond if the second trigger indicates a use case or type of PUE different from the use case or the PUE type of the PUE 115-d.

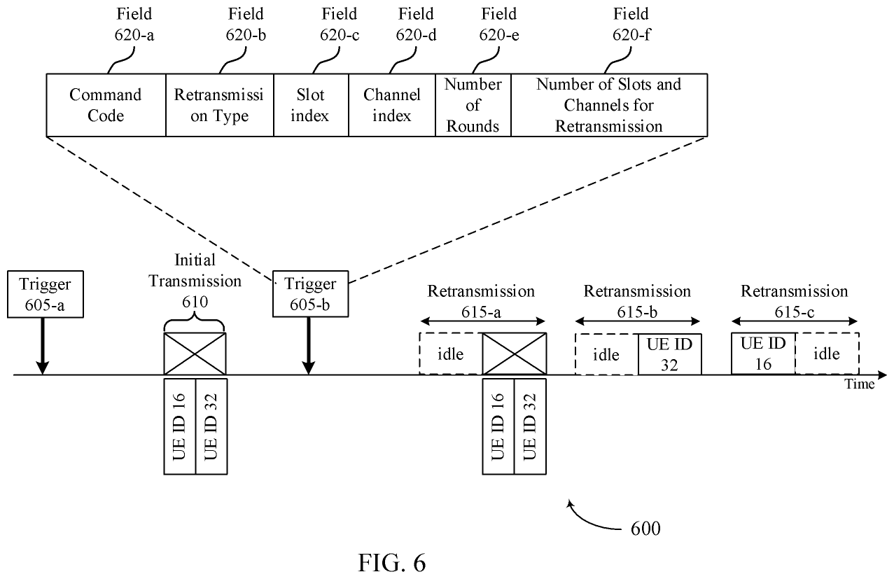

In some examples, the network entity 105-c may transmit, and the PUE 115-d may receive, an instruction to retransmit the first initial access response message based on transmitting the first initial access response message. For example, the PUE 115-d may be unsuccessful in transmitting the first initial access response message (e.g., the transmitted initial access response message including the UE ID may encounter a collision, experience a delay, or the PUE 115-d may not identify available resources for transmission). In some examples, the network entity 105-c may transmit an instruction to retransmit the initial access response message based on a failure to receive the first initial access response message. In such an example, the PUE 115-d may retransmit the first initial access response message to the network entity 105-c based on the instruction to retransmit, as described in greater detail with reference to FIG. 6.

In some examples, the PUE 115-d may receive, in the instruction to retransmit the first initial access response message, an indication of a subset of retransmission resources of a set of multiple retransmission resources during which the PUE 115-d is permitted to retransmit the first initial access response message. In some examples, the PUE 115-d may determine a response rate for the retransmission of the first initial access response message. In some examples, the PUE 115-d may retransmit the first initial access response message according to the response rate using one or more retransmission resources of the subset of retransmission resources. In some examples, the network entity 105-c may transmit, and the PUE 115-d may receive, an instruction to adjusting the response rate, the muting ratio, or a combination thereof, based on the network entity 105-c receiving the first initial access response message. In some examples, the transmission and reception of the retransmission of the first initial access response message may be based on the transmission and reception of the instruction.

In some examples, the network entity 105-c may transmit, and a second PUE may receive, a second initial access trigger message including an indication of a different use case or type of PUE (e.g., the first latency non-critical use case or PUE type). In some examples, the second PUE may transmit, and the network entity 105-c may receive, and a second initial access response message on one or more initial access resources associated with the second use case or type of PUE based on the second PUE operating according to the second use case or being the second type of PUE. In some examples, the second initial access response message may include an identifier associated with the second use case or type of PUE. In some examples, the second PUE may transmit a data message, receive instructions regarding a muting ratio, and perform operations with the network entity 105-c similar to the operations described herein with respect to the first PUE 115-d.

In some examples, the PUE 115-d may demodulate a first carrier signal associated with the first initial access trigger message, and may backscatter a second carrier signal based on the modulated first carrier signal (e.g., as described with reference to FIG. 2). In some examples, the one or more additional carrier signals may include the initial access response message. In such examples, the PUE 115-d may be any type of UE or may operate according to any use case, including the latency critical and the latency non-critical use case and PUE types described with reference to FIG. 3. A first carrier signal including a first trigger message may initiate a first type of use case (e.g., latency critical data transmission) and a second trigger message may initiate a different type of use case (e.g., latency non-critical data transmission).

FIG. 5 illustrates an example of an initial access scheme 500 that supports initial access and device identification protocol design for passive IoT in accordance with one or more aspects of the present disclosure. In some examples, the initial access scheme 500 may implement, or be implemented by, aspects of the wireless communications systems 100, 200, or 300. In some examples, the initial access scheme 500 may implement, or be implemented by, aspects of the process flow 400. In particular, the initial access scheme 500 illustrates configurations and signaling which may enable PUEs (e.g., PUEs of the first latency non-critical use case or PUE type) to be grouped into different frames 510, slots 520, and frequency channels 525 to restrict the total number of PUEs to access at the same time, which may improve efficiency.

The initial access scheme 500 may include a latency non-critical initial access resources 505. In some examples, the latency non-critical initial access resources 505 may include frames 510-a through 510-e (and any number of intervening frames 510), slots 520-a through 520-f (and any number of intervening slots 520), and channels 525-a through 525-d (and any number of intervening channels 525). In some examples, the frames 510 may represent examples of single frequency networks (SFNs). In some examples, the network entity may assign one or more initial access resources to each frame 510 (e.g., a number of slots 520 and channels 525) based on the number of PUEs per frame 510 (e.g., based on a number of users). In some examples, the network entity may assign one or more initial access resources to each slot 520 (e.g., a number of channels 525) based on the number of PUEs per slot 520 (e.g., based on a number of users).

The initial access scheme 500 may also include PUEs associated with respective UE IDs (e.g., temporary IDS) including UE ID 0, UE ID 16, UE ID 32, UE ID 48, UE ID 15, UE ID 31, UE ID 47, and UE ID 63, which may be examples of PUEs 115 as described with reference to FIGS. 1-4. For example, the PUE associated with the UE ID 0 (or any other UE ID illustrated in FIG. 5) may represent an example of the PUE 115-b, as described with reference to FIG. 3, where the PUE associated with the UE ID 0 (and other UE IDs illustrated) may operate according to a use case or may be a defined type of PUE (e.g., the first, latency non-critical PUE type or use case as described with reference to FIG. 3). In some examples, the PUEs may be, and the operations described herein may be performed by, any other type of UE (e.g., a latency critical PUE, a UE, a smart device, a wearable device, or a low capacity UE). In some examples, the PUEs may be connected to a network entity similar to the network entity 105-b as described with reference to FIG. 3. In some examples, the network entity may represent an example of any type of network entity (e.g., a network entity, an RFID reader, a CU, a DU, an RU, an RIC, or an SMO).

For latency non-critical initial access, the PUEs may be grouped into different frames 510, slots 520, and frequency channels 525 to restrict a total number of PUEs to access at the same time for improving efficiency. In some examples, the PUE associated with the UE ID 0 (or any of the PUEs illustrated in FIG. 5) may receive, from a network entity, a first configuration message indicating latency non-critical initial access resources 505. The latency non-critical initial access resources 505 may be defined by one or more parameters. The configuration message may indicate a periodicity of a set of multiple access frames 510 (e.g., the frames 510-a through 510-e) associated with the use case or the type of PUE of the PUE associated the UE ID 0 and a number of available access frames 510 of the set of multiple access frames 510 during a first period. The first configuration message may higher layer signaling (e.g., an RRC message, or a MAC-CE, among other examples), or may be dynamic signaling (e.g., a DCI message), or a combination thereof (e.g., semi-persistent scheduled signaling). In some examples, a first access frame 510 (e.g., the frame 510-a) of the set of multiple access frames 510 may include one or more initial access resources assigned to the first access frame 510. In some examples, the use case or type of PUE may be associated with pre-stored sensor data transmissions of a lower priority level (e.g., the first, lower priority, latency non-critical use case or PUE type), and a different use case or type of PUE may be associated with sensor data transmissions of a higher priority level (e.g., the second, higher priority, latency critical use case or PUE type).

In some examples, each PUE (e.g., any of the PUEs illustrated in FIG. 5) may determine to use (e.g., select) an access frame 510 (e.g., from the set of multiple access frames 510) based on an identifier associated with the PUE (e.g., a UE ID), a periodicity of the access frames 510, a number of available access frames 510, or a combination thereof. For example, the PUE associated the UE ID 0 may use the ID to determine to use an access frame 510 (e.g., the frame 510-a) to transmit an initial access response message based on a cell specific configuration, and a predefined mapping of the UE ID and the frame index. Thus, the PUEs may divided into different frames 510. For example, the network entity may provide configuration information including the periodicity (e.g., a periodicity T of the frames 510) and a number of access frames 510 (e.g., a number N of access frames 510 number), where the number N of access frames 510 may be configured according to the periodicity (e.g., oneT, halfT, oneEighthT, oneSixteenthT, among other examples). Thus, the configuration information may provide for a periodicity P of frames 510, and a number N of frames 510 during each period of the periodicity.

In some examples, a PUE (e.g., any of the PUEs illustrated in FIG. 5) may determine a frame 510 in which to transmit an initial access message according to a predefined (e.g., standardized, preconfigured at the PUE, or configured by the network entity) mapping between UE IDs and frame indices. For example, a PUE may determine an access frame 510 according to Equation 1:

$$SFN mod T = ( T div N ) \times ( UE\_ID mod N ) )$$

For example, a network entity may determine an N of halfT. In such examples, the PUE may calculate the SFN of a frame 510 according to Equation 1, where (e.g., because of the N of halfT), the frame is one of the frames 510-a, 510-c, or frame 510-d (e.g., half of the frames 510 within a period T are available for transmitting initial access messages responsive to a trigger 305, the other half of frames 510, including frame 510-b and frame 510-e may be unavailable).

In some examples, the PUE associated the UE ID 0 (or any of the PUEs) may select (e.g., may random select or may be assigned) the one or more initial access resources from a set of time resources (e.g., slots 520) associated with the selected access frame, a set of frequency resources (e.g., channels 525) associated with the selected access frame, or both. For example, the PUE may be configured to dynamically select a slot 520 within the selected frame based on a trigger command. The PUE associated the UE ID 0 may receive a trigger command, and may determine to respond to the trigger command if the trigger command matches the use case or the PUE type of the PUE associated the UE ID 0 (e.g., a trigger 305-a as described with reference to FIG. 3 may indicate the first latency non-critical use case or PUE type). For example, the PUE associated the UE ID 0 may select the slot 520-a for transmissions.

In some examples, the PUE associated the UE ID 16, the PUE associated the UE ID 32, and the PUE associated the UE ID 48 may additionally be configured for or may select the first frame (e.g., frame 510-a) according to the preconfigured mapping (e.g., equation 1), and may also select a respective slot 520 within identified frames 510. For example, the PUE associated the UE ID 16 and the PUE associated the UE ID 32 may both select the slot 520-c within frame 510-a, and the PUE associated the UE ID 48 may select the slot 520-d within frame 510-a. In some examples, the PUE associated the UE ID 0 and the PUE associated the UE ID 48 may successfully transmit initial access messages (e.g., may transmit their respective UE IDs). In some examples, the PUE associated the UE ID 16 and the PUE associated the UE ID 32 may experience collisions due to selecting the same slot 520-c. In some examples, none of the PUEs may select the slot 520-b, and thus the slot 520-b may be unselected (e.g., may be ‘idle’). In some examples, the PUEs may be preconfigured to use the frame 510-a. In some examples, the PUEs may determine to respond to the trigger command due to the trigger command indicating a matching frame 510 (e.g., the first frame 510-a).

In some examples, the network entity may configure or reconfigure a number of slots 520 and channels 525 in each frame 510 via one or more observations. For example, during or after a period, the network entity may identify one or more observations, such as a number of idle slots 520, a number of collision slots 520, a successful slot quantity (e.g., a number of slots 520 in which successful initial access transmissions occurred) in a previous period, or the like. For example, a network entity may configure the PUEs with a first value for T and N, and may further (e.g., semi-statically) indicate resources within each frame 510. For instance, the network entity may configure a number of time resources (e.g., four slots 520, including slot 520-a, slot 520-b, slot 520-c, and slot 520-d), and a number of frequency resources (e.g., one channel 525). The network entity may transmit one or more triggers, and one or more PUEs of the multiple PUEs (e.g., the PUE associated with UE ID 0, the PUE associated with UE ID 16, the PUE associated with UE ID 32, and the PUE associated with the UE IE 48) may respond to the trigger by identifying the frame 510-a (e.g., according to equation 1) and selecting resources within the frame 510-a (e.g., a slot 520 on the single channel 525 associated with the frame 510-a).

The network entity may detect an idle slot quantity (e.g., the idle slot 520-c), a collision slot quantity (e.g., the collision in slot 520-c), or a successful slot quantity (e.g., the successful slots 520-a and 520-d) in a last access period (e.g., including one or more frames 510, such as the frame 510-a). The network entity may determine, based on the detections in the period including the frame 510-a, to adjust the resource allocation (e.g., a number of slots 520, channels 525, or both) associated with the frames 510 for later frames 510. For instance the network entity may reallocate resources such that each frame 510 (e.g., frame 510-d and frame 510-e) includes a number of time resources (e.g., two slots 520, including slot 520-e and slot 520-f) and a number of frequency resources (e.g., two channels 525 per slot 520, including channel 525-a and channel 525-b for the slot 520-e, and channel 525-c and channel 525-d for the slot 520-f). In such examples, the network entity may transmit another trigger, and one or more PUEs of the multiple PUEs (e.g., the PUE associated with the UE ID 15, the PUE associated with the UE ID 31, the PUE associated with the UE ID 47, and the PUE associated with the UE ID 63) may respond to the trigger. The PUEs may select slots 520 and channels 525 associated with a frame 510 identified using the equation 1. For instance, the PUE associated with the UE ID 15 may transmit an initial access response message on the channel 525-a during the slot 520-e, and the PUE associated with the UE ID 31 may transmit an initial access response message on the channel 525-b during the same slot 520-e (e.g., the two initial access response messages may be FDMed). The PUE associated with the UE ID 47 and the PUE associated with the UE ID 63 may both transmit initial access response messages on the channel 525-c during the slot 520-f, resulting in a collision, while the channel 525-d during the slot 520-f may remain idle. Thus, the network entity may configure or reconfigure resource allocation for the frames 510 based on observed collisions, availability, and successful transmissions.

In some examples, the network entity may determine the number of channels 525 based on a number of resources and based on dynamic sharing of resources. In some examples, the network entity may configure resources according to observations based on assuming that the number of PUEs will not change suddenly from one period to another (e.g., will not increase or decrease suddenly between any two frames 510). In some examples, the network entity may dynamically indicate resource allocations for the frames 510. In some examples, the network entity may configure PUEs with various candidate frame structures (e.g., numbers of slots 520 and channels 525), and may semi-persistently activate or select frame structures from the candidate frame structures. In some examples, the network entity may semi-statically or periodically transmit updated frame structure configuration information to the PUEs.

In some examples, the network entity may further mitigate collisions as described in further detail with reference to FIG. 6. In some examples, the PUE preselection based on UE ID and frame index mapping described herein may be performed before performing other network or PUE processes (e.g., before performing slotted ALOHA).

In some examples, the PUEs may receive configuration messages to indicate resources for later time frames 510. For example, the PUE associated the UE ID 0 may receive from the network entity, a second configuration message including an indication of a number of time resources (e.g., a number of slots 520) associated with each respective access frame 510 of a set of multiple access frames 510 during the first period, a number of frequency resources (e.g., a number of channels 525) associated with each respective access frame 510 of the set of multiple access frames 510 during the first period, or a combination thereof (e.g., indicating slots 520 and channels 525 for the first frame 510-a). In some examples, after detecting the number of collisions during the first period between the PUEs including the PUE associated the PUE ID 0, the number of idle resources of the number of time resources, the number of frequency resources, or any combination thereof (e.g., after making the observations of a period during the frame 510-a), the network entity may transmit, and the PUEs may receive, a third configuration message including an indication of a second number of time resources (e.g., a number of slots 520) associated with each respective access frame 510 of the set of multiple access frames 510 during a second time period, a second number of frequency resources associated with each respective access frame 510 of the set of multiple access frames 510 during the time period, or a combination thereof (e.g., indicating slots 520 and channels 525 for the later frame 510-d). In some examples, any other PUE of the PUEs may receive the second or third configuration messages.

FIG. 6 illustrates an example of a timeline 600 that supports initial access and device identification protocol design for passive IoT in accordance with one or more aspects of the present disclosure. In some examples, the timeline 600 may implement, or be implemented by, aspects of the wireless communications systems 100, 200, or 300, or by the process flow 400 or by the initial access scheme 500. In particular, the timeline 600 illustrates configurations and signaling which may support retransmissions for a UE or PUE of either the latency non-critical or the latency critical use case or PUE types described herein. The operations described in the timeline 600 may be performed in a different order than the order shown or at different times. Some operations may be omitted from the timeline 600, or other operations may be added to the timeline 600.

The timeline 600 may include a trigger 605-a and a trigger 605-b. In some examples, the triggers 605 may both represent examples of either the first trigger 305-a or the second trigger 305-b as described with reference to FIG. 3. The timeline 600 may also include an initial transmission 610, as well as retransmissions 615-a through 615-c, which may both represent examples of either the first response 310-a or the second response 310-b as described with reference to FIG. 3. In some examples, the triggers 605 may be sent by a network entity (e.g., a network entity 105 as described with reference to FIGS. 1-5). In some examples, the initial transmission 610 and the retransmissions 615 may be sent to the network entity, or to other network entities. The timeline 600 may also include a first PUE associated with a UE ID 16, and a second PUE associated with a UE ID 32. The first PUE associated the UE ID 16 and the second PUE associated the UE ID 32 may represent examples of PUEs 115 or UEs 115 as described with reference to FIGS. 1-5. For example, the first PUE associated the UE ID 16 and the second PUE associated the UE ID 32 may represent examples of the PUE associated the UE ID 16 and the PUE associated the UE ID 32 with a collision as described with reference to FIG. 5. In some examples, the first PUE associated the UE ID 16 and the second PUE associated the UE ID 32 may operate according to the latency non-critical use case or may be the latency non-critical PUE type, or may operate according to the latency critical use case or may be the latency critical PUE type. In some examples, the PUEs may be, and the operations described herein may be performed by, any other type of UE (e.g., a UE, a smart device, a wearable device, or a low capacity UE, among other examples).

In some examples, the first PUE associated with the UE ID 16 and the second PUE associated with the UE ID 32 may receive the first trigger 605-a. In some examples, the network entity may transmit the first trigger 605-a, and may cause the first PUE associated the UE ID 16 and the second PUE associated the UE ID 32 to respond by transmitting an initial transmission 610 to the network entity (e.g., an initial access response transmission including the UE IDs). In some examples, the first PUE and the second PUE may transmit initial access response messages during a same time or frequency resources (e.g., as described with reference to FIG. 4 or FIG. 5), resulting in a collision.

In some examples, the network entity may transmit a second trigger 605-b. The second trigger 605-b may include one or more fields 620. In some examples, the second trigger 605-b may include one or more of the same fields 620 as the first trigger 605-a (e.g., different fields 620 may be set to different values for trigger 605-a and trigger 605-b). For example, the second trigger 605-b may include fields 620-a through 620-f. In some examples, the field 620-a may include a command code, which may indicate access (e.g., may be set to or may equal ‘Access’). In some examples, the command code may indicate that a receiving PUE is to attempt initial access, based at least in part on the ‘Access” command included in the field 620-a. In some cases, the field 620-b may include an indication of a retransmission, which may indicate to a PUE whether or not to send an initial transmission or a retransmission (e.g., a ‘0’ may indicate to send an initial transmission, whereas a ‘1’ may indicate to send a retransmission). In some examples, the field 620-c may include a slot index associated with the initial transmission 610. In some examples, the field 620-d may include a channel index associated with the initial transmission 610 (e.g., an unsuccessful initial transmission 610, due to a collision). The field 620-c and the field 620-d may be used by the network entity to select correct PUEs (e.g., PUEs associated with the unsuccessful initial transmission) to respond to the trigger 605-b with retransmissions 615. Any PUEs that receive the trigger 605-b but that did not send a transmission during the channels or slots indicated in the field 620-c and the field 620-d may ignore (e.g., may refrain from responding to) the trigger 605-b. In some examples, the field 620-e may indicate a number of rounds for sending retransmissions 615 (e.g., 3 rounds). In some examples, the field 620-f may indicate a number of slots and a number of channels available for the retransmission (e.g., may indicate time and frequency resources on which to send retransmissions 615 during respective rounds of retransmission, as indicated in field 620-e).

In some examples, a PUE may successfully transmit an initial access response message. In such examples, such a PUE may mute or reduce its response rate after a successful transmission of an initial access response message. For example, if the PUE is successfully identified (e.g., the PUE transmits a UE ID in response to a trigger, or receives an ACK message, as described in greater detail with reference to FIGS. 3-4), then the PUE may be muted after being successfully identified for a configured time frame of multiple periodicities, or may be instructed (e.g., by the network entity) to reduce its response rate in a next access period (e.g., by increasing its muting ratio as described with reference to FIG. 4). In some examples, reducing the response rate of the first PUE associated with the UE ID 16 may give other UEs or PUEs an opportunity to respond. In some examples, the second PUE associated with the UE ID 32 may send a successful initial transmission 610 and may be muted accordingly.

In some examples, the network entity may detect the collision of the initial transmission 610 (e.g., may fail to receive any initial access response message during the resources of the initial transmission 610, may detect an energy level during the resources of the initial transmission 610, may receive one or more initial access messages but may fail to decode the initial access messages based on detected interference or collision, among other examples), and may transmit the second trigger 605-b. For example, the second trigger 605-b may represent a trigger similar to the first trigger 605-a, and may include the fields 620-a through 620-f In some examples, the field 620-b of the second trigger 605-b may indicate a retransmission (e.g., the retransmission type may equal ‘1’), whereas a field 620-b in the trigger 605-a may indicate an initial transmission (e.g., the retransmission type may equal ‘0’).

As described herein, the trigger 605-b (e.g., with retransmission type set to ‘1’) may schedule multiple rounds of retransmission (e.g., the field 620-e may indicate 3 rounds of retransmission). In such examples, the first PUE associated with the UE ID 16 and the second PUE associated with the UE ID 32 may reduce their respective response rates (e.g., p) after each round of retransmission. For example, the first PUE and the second UE may determine to send a retransmission according to a response rate p. (in response to the second trigger 605-b indicating retransmission with the field 620-b is equal to ‘1’) in a given round j according to according to pⱼ=2^{-j} for every j-th round. In some examples, after a first round, the first PUE associated with the UE ID 16 and the second PUE associated with the UE ID 32 may halve their response rates for each additional round of retransmission. Thus, for the first round j=0 (e.g., round 0) of the three rounds indicated by the second trigger 605-b, the response rate p. may represent a 100% probability for response (e.g., p₀=2⁻⁰=1 may indicate a 1/1 chance for response). In such an example, both the first PUE and the second PUE may determine to transmit during the resource indicated in the field 620-f for the first round 0 (e.g., retransmission 615-a), resulting in another collision. For the second round (e.g., round 1), the response rates may be halved, and the PUEs may transmit at a 50% probability for response (e.g., p₀=2⁻⁰=0.5 may indicate a z probability for response). In such an example, one or more PUEs (e.g., including the PUE associated with the UE ID 32) may determine to transmit a retransmission during the resources of second retransmission 615-b, and the other PUEs (e.g., including the PUE associated with the UE ID 16) may determine to refrain from retransmissions based on the 50% probability (e.g., half of the PUEs that transmitted during round 0 may transmit during round 1). For the third round (e.g., round 2), the response rates may be halved again, and the UEs may transmit at a 25% probability for response (e.g., p₂=2⁻²=0.25 may indicate a 4 probability for response). In such examples, the second PUE associated with the UE ID 32 may refrain from transmitting during retransmission 615-c, but the first PUE associated with the PUE ID 16 may transmit during the retransmission 615-c. Because the PUEs continue to reduce their response rate by half during successive rounds of retransmission, each PUE may increase the likelihood of at least one successful retransmission (e.g., with reduced odds of conflict) during each successful round of retransmission 615.

In some examples, the first PUE associated the UE ID 16 and the second PUE associated the UE ID 32 may make different determinations for each retransmission 615 than the decisions described herein based on their respective response rates. For example, the first PUE and the second PUE may both determine to transmit in the second round of retransmission, and may both either send successful retransmissions for the second retransmission 615-b by selecting different resources, or may experience another collision by selecting the same resource. Both PUEs may alternatively determine to refrain from retransmissions during the second round of retransmission, and may both determine to transmit or determine to refrain from retransmissions during the third round, and may experience successful retransmissions or collisions accordingly. In some examples, a greater or lesser amount of rounds may be specified by the field 620-e and the first PUE associated the UE ID 16 and the second PUE associated the UE ID 32 may send retransmissions for the number of rounds specified accordingly. In some examples, the operations described herein may be performed at the same time, at different times, or in any other order. In some examples, the operations describe herein may mitigate collisions between PUEs (or other UEs), and may provide more opportunities for each PUE (and other UEs) to respond to a trigger sent by a network entity.

In some examples, as described with reference to FIGS. 2-6, frequencies of a power of 2 relative to a reference frequency may be used for FDM to mitigate harmonic interference. For example, a wireless communications system may implement FDM for communications (e.g., to divide the slots into channels as described with reference to FIGS. 2-6). In some examples, the following operations may be performed for either use case or either PUE type.

In some examples, communications based on backscatter modulation (e.g., as described with reference to FIGS. 2-6) may rely on a subcarrier modulated FSK scheme. For instance, tag switches with a square wave may operate at a Δf to modulate antenna impedance therefore, a baseband frequency may be shifted by Δf relative to the carrier frequency (e.g., as described in greater detail with reference to FIG. 2. However, subcarrier modulation based on square waves may generate sideband harmonic interference because a square wave at a rate of Δf may be defined as the sum of a set of cosine waves

$$( e . g . , Square ( Δ f t ) = \frac{4}{π} {\sum }_{n = 0}^{∞} \frac{1}{2 n + 1} cos ( 2 π ( 2 n + 1 ) Δ f t ) ) .$$

This may result in harmonic interference.

In some examples, the wireless communications system may use frequencies of a power of 2 relative to a reference frequency to mitigate such harmonic interference, where frequencies of 2^{m}×Δf are employed. In some examples, m may represent an integer where m=0 . . . M−1, where M may represent a number of channels indicated by a trigger command (e.g., the trigger commands 305 or trigger 605 as described with reference to FIGS. 3 and 6). In some examples, Δf may represent a configured link frequency for backscatter modulation. The described operations may also be implemented by techniques described with reference to any of FIGS. 2-6.

Examples of frequencies of a power of two compared to harmonic interference frequencies are illustrated in Table 1. Other mappings are contemplated and within scope of the techniques described herein.

TABLE 1

| FSK offset | Desired | Harmonic |
|---|---|---|
| index m | frequency shift | Interference |
| 0 | Δf | 3Δf, 5Δf, 7Δf, 9Δf, 11Δf, . . . |
| 1 | 2Δf | 6Δf, 10Δf, 14Δf, 18Δf, 22Δf, . . . |
| 2 | 4Δf | 12Δf, 20Δf, 28Δf, 36Δf, 44Δf, . . . |

Frequency-shift Keying (FSK) offsets 0, 1, and 2 are considered. For FSK offset 0, a desired frequency shift of a power of 2 relative to a reference frequency according to the described operations may be represented by Δf (e.g., 2⁰×Δf). For FSK offset 1, a desired frequency shift of a power of 2 relative to a reference frequency according to the described operations may be represented by 2Δf (e.g., 2¹×Δf). For FSK offset 2, a desired frequency shift of a power of 2 relative to a reference frequency according to the described operations may be represented by 4Δf (e.g., 2²×Δf).

Corresponding harmonic interference may take place at respective frequencies shown in the third column of Table 1. In some examples, respective harmonics series may not include respective frequencies of a power of 2. For example, for FSK offset 0, harmonic interference may take place at 3Δf, 5Δf, 7Δf, 9Δf, 11Δf, and at further frequencies following this pattern. For FSK offset 1, harmonic interference may take place at 6Δf, 10Δf, 14Δf, 18Δf, 22Δf and at further frequencies following this pattern. For example, for FSK offset 2, harmonic interference may take place at 12Δf, 20Δf, 28Δf, 36Δf, 44Δf, and at further frequencies following this pattern.

Employing frequencies of a power of 2 relative to a reference frequency may thus mitigate harmonic interference for each scenario. For example, for FSK offset index 0 and a desired frequency shift of a power of 2 of Δf, harmonic interference may take place at 3Δf, 5Δf, 7Δf, 9Δf, 11Δf, and other following frequencies in the series, which may not represent any frequencies of a power of 2.

In some examples, the network entity 105-c may transmit, and the PUE 115-d may receive, an indication of a supported frequency shift for subcarrier modulation. In some examples, the PUE 115-d may perform a subcarrier modulation procedure based on the supported frequency shift and a number of frequency channels indicated for the one or more initial access resources in the first initial access trigger message. In some examples, receiving the first initial access response message may be based on the indication of the supported frequency shift. The described frequency shift indication and subcarrier modulation procedure are described in greater detail with reference to FIG. 6. In such examples, the PUE 115-d may be any type of UE or may operate according to any use case, including the latency critical and the latency non-critical use case and PUE types described with reference to FIG. 3.

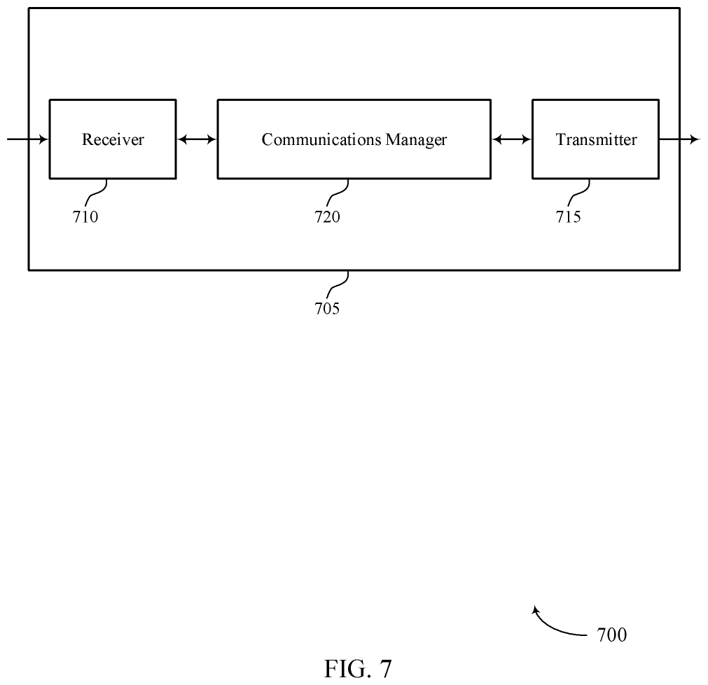

FIG. 7 shows a block diagram 700 of a device 705 that supports initial access and device identification protocol design for passive IoT in accordance with one or more aspects of the present disclosure. The device 705 may be an example of aspects of a UE 115 as described herein. The device 705 may include a receiver 710 (e.g., which may include a harvester to collect energy from incident radio-frequency waves, such as a PUE 115 as described with reference to FIGS. 2-6), a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to initial access and device identification protocol design for passive IoT). Information may be passed on to other components of the device 705. The receiver 710 may utilize a single antenna or a set of multiple antennas.

The transmitter 715 may provide a means for transmitting signals generated by other components of the device 705 (e.g., means for backscatter modulation for transmitting data). For example, the transmitter 715 may transmit information such as packets, user data, control information, or any combination thereof associated with various information channels (e.g., control channels, data channels, information channels related to initial access and device identification protocol design for passive IoT). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of initial access and device identification protocol design for passive IoT as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software) executed by a processor. If implemented in code executed by a processor, the functions of the communications manager 720, the receiver 710, the transmitter 715, or various combinations or components thereof may be performed by a general-purpose processor, a DSP, a CPU, a graphics processing unit (GPU), an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a passive UE in accordance with examples as disclosed herein. For example, the communications manager 720 may be configured as or otherwise support a means for receiving, from a network entity, an initial access trigger message including an indication of a first type of passive UE of a set of multiple types of passive UEs. The communications manager 720 may be configured as or otherwise support a means for selecting one or more initial access resources based on the passive UE being the first type of passive UE. The communications manager 720 may be configured as or otherwise support a means for transmitting, to the network entity on the one or more initial access resources, an initial access response message including an identifier associated with the passive UE.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption, reduced latency in communications, faster processing, and efficient utilization of communication resources.

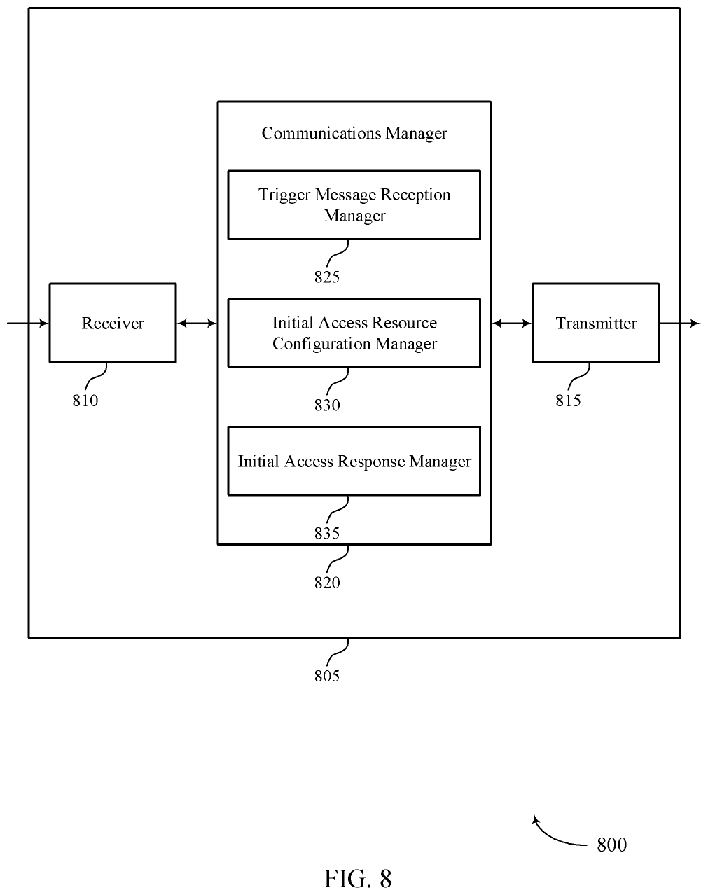

FIG. 8 shows a block diagram 800 of a device 805 that supports initial access and device identification protocol design for passive IoT in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to initial access and device identification protocol design for passive IoT). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to initial access and device identification protocol design for passive IoT). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of initial access and device identification protocol design for passive IoT as described herein. For example, the communications manager 820 may include a trigger message reception manager 825, an initial access resource configuration manager 830, an initial access response manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a passive UE in accordance with examples as disclosed herein. The trigger message reception manager 825 may be configured as or otherwise support a means for receiving, from a network entity, an initial access trigger message including an indication of a first type of passive UE of a set of multiple types of passive UEs. The initial access resource configuration manager 830 may be configured as or otherwise support a means for selecting one or more initial access resources based on the passive UE being the first type of passive UE. The initial access response manager 835 may be configured as or otherwise support a means for transmitting, to the network entity on the one or more initial access resources, an initial access response message including an identifier associated with the passive UE.

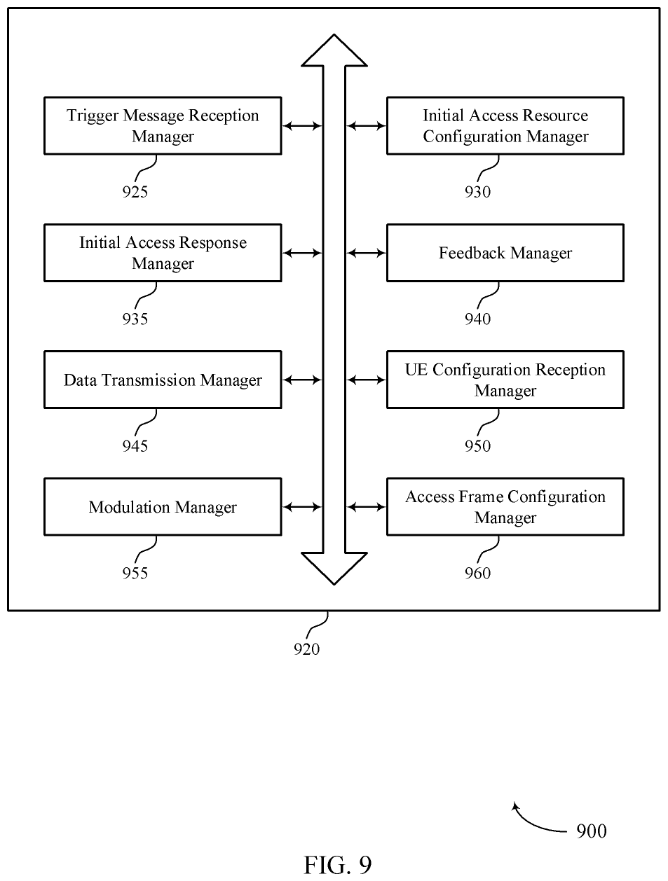

FIG. 9 shows a block diagram 900 of a communications manager 920 that supports initial access and device identification protocol design for passive IoT in accordance with one or more aspects of the present disclosure. The communications manager 920 may be an example of aspects of a communications manager 720, a communications manager 820, or both, as described herein. The communications manager 920, or various components thereof, may be an example of means for performing various aspects of initial access and device identification protocol design for passive IoT as described herein. For example, the communications manager 920 may include a trigger message reception manager 925, an initial access resource configuration manager 930, an initial access response manager 935, a feedback manager 940, a data transmission manager 945, a UE configuration reception manager 950, a modulation manager 955, an access frame configuration manager 960, or any combination thereof. Each of these components may communicate, directly or indirectly, with one another (e.g., via one or more buses).

The communications manager 920 may support wireless communications at a passive UE in accordance with examples as disclosed herein. The trigger message reception manager 925 may be configured as or otherwise support a means for receiving, from a network entity, an initial access trigger message including an indication of a first type of passive UE of a set of multiple types of passive UEs. The initial access resource configuration manager 930 may be configured as or otherwise support a means for selecting one or more initial access resources based on the passive UE being the first type of passive UE. The initial access response manager 935 may be configured as or otherwise support a means for transmitting, to the network entity on the one or more initial access resources, an initial access response message including an identifier associated with the passive UE.

In some examples, the feedback manager 940 may be configured as or otherwise support a means for receiving, from the network entity based on transmitting the initial access response message, an initial access acknowledgment message including the identifier associated with the passive UE. In some examples, the data transmission manager 945 may be configured as or otherwise support a means for transmitting, based on the initial access acknowledgment message, a data message to the network entity.

In some examples, to support transmitting the initial access response message, the initial access response manager 935 may be configured as or otherwise support a means for transmitting the initial access response message according to a muting ratio associated with the first type of passive UE, where the first type of passive UE is associated with sensor data transmissions of a first priority level and the second type of passive UE is associated with pre-stored sensor data transmissions of a second priority level that is lower than the first priority level.

In some examples, the initial access response manager 935 may be configured as or otherwise support a means for selecting, based on an amount of time in a timing budget for transmitting the data message, the muting ratio from a set of multiple candidate muting ratios of a set of multiple candidate muting ratios, each muting ratio of the set of multiple candidate muting ratios indicating a respective ratio between a number of initial access response messages and a set of periodic initial access trigger messages including the initial access trigger message, where the data message includes high priority sensor data.

In some examples, the UE configuration reception manager 950 may be configured as or otherwise support a means for receiving, from the network entity, an indication of the set of multiple candidate muting ratios.

In some examples, to support transmitting the initial access response message, the initial access response manager 935 may be configured as or otherwise support a means for generating a slot number associated with the one or more initial access resources from a set of slot numbers, where the initial access trigger message includes an indication of the set of slot numbers. In some examples, to support transmitting the initial access response message, the initial access response manager 935 may be configured as or otherwise support a means for transmitting the initial access response message when the generated slot number satisfies a condition.

In some examples, the UE configuration reception manager 950 may be configured as or otherwise support a means for receiving, from then network entity, a first configuration message indicating a periodicity of a set of multiple access frames associated with the first type of passive UE and a number of available access frames of the set of multiple access frames during a first period, where a first access frame of the set of multiple access frames includes the one or more initial access resources, where the first type of passive UE is associated with pre-stored sensor data transmissions of a first priority level and the second type of passive UE is associated with sensor data transmissions of a second priority level that is higher than the first priority level.

In some examples, the access frame configuration manager 960 may be configured as or otherwise support a means for determining the first access frame from the set of multiple access frames based on an identifier associated with the passive UE, the periodicity, the number of available access frames, or a combination thereof. In some examples, the initial access resource configuration manager 930 may be configured as or otherwise support a means for randomly selecting the one or more initial access resources from a set of time resources associated with the first access frame, a set of frequency resources associated with the first access frame, or both.

In some examples, the UE configuration reception manager 950 may be configured as or otherwise support a means for receiving, from the network entity, a second configuration message including an indication of a number of time resources associated with each respective access frame of the set of multiple access frames during the first period, a number of frequency resources associated with each respective access frame of the set of multiple access frames during the first period, or a combination thereof.

In some examples, the UE configuration reception manager 950 may be configured as or otherwise support a means for receiving, from the network entity, a third configuration message including an indication of a second number of time resources associated with each respective access frame of the set of multiple access frames during a second period, a second number of frequency resources associated with each respective access frame of the set of multiple access frames during the second period, or a combination thereof.

In some examples, the trigger message reception manager 925 may be configured as or otherwise support a means for receiving, from the network entity, a second initial access trigger message including a second indication of the first type of passive UE. In some examples, the initial access response manager 935 may be configured as or otherwise support a means for refraining from transmitting a second initial access response message based on transmitting the initial access response message.

In some examples, the initial access response manager 935 may be configured as or otherwise support a means for adjusting a response rate, a muting ratio, or a combination thereof, based on transmitting the initial access response message, where the refraining is based on the adjusting.

In some examples, the trigger message reception manager 925 may be configured as or otherwise support a means for receiving, from the network entity based on transmitting the initial access response message, an instruction to retransmit the initial access response message. In some examples, the initial access response manager 935 may be configured as or otherwise support a means for retransmitting the initial access response message to the network entity based on the instruction.

In some examples, the trigger message reception manager 925 may be configured as or otherwise support a means for receiving, in the instruction to retransmit the initial access response message, an indication of a subset of retransmission resources of a set of multiple retransmission resources during which the passive UE is permitted to retransmit the initial access response message. In some examples, the initial access response manager 935 may be configured as or otherwise support a means for determining a response rate for a retransmission of the initial access response message where retransmitting the initial access response message includes retransmitting the initial access response message according to the response rate using one or more of the subset of retransmission resources.

In some examples, the UE configuration reception manager 950 may be configured as or otherwise support a means for receiving, from the network entity, an indication of a supported frequency shift for subcarrier modulation. In some examples, the modulation manager 955 may be configured as or otherwise support a means for performing, based on the supported frequency shift and a number of frequency channels indicated for the one or more initial access resources in the initial access trigger message, a subcarrier modulation procedure, where transmitting the initial access response message is based on the subcarrier modulation procedure.

In some examples, to support transmitting the initial access response message, the modulation manager 955 may be configured as or otherwise support a means for modulating a first carrier signal associated with the initial access trigger message. In some examples, to support transmitting the initial access response message, the initial access response manager 935 may be configured as or otherwise support a means for backscattering a second carrier signal based on the modulated first carrier signal, where the second carrier signal includes the initial access response message.

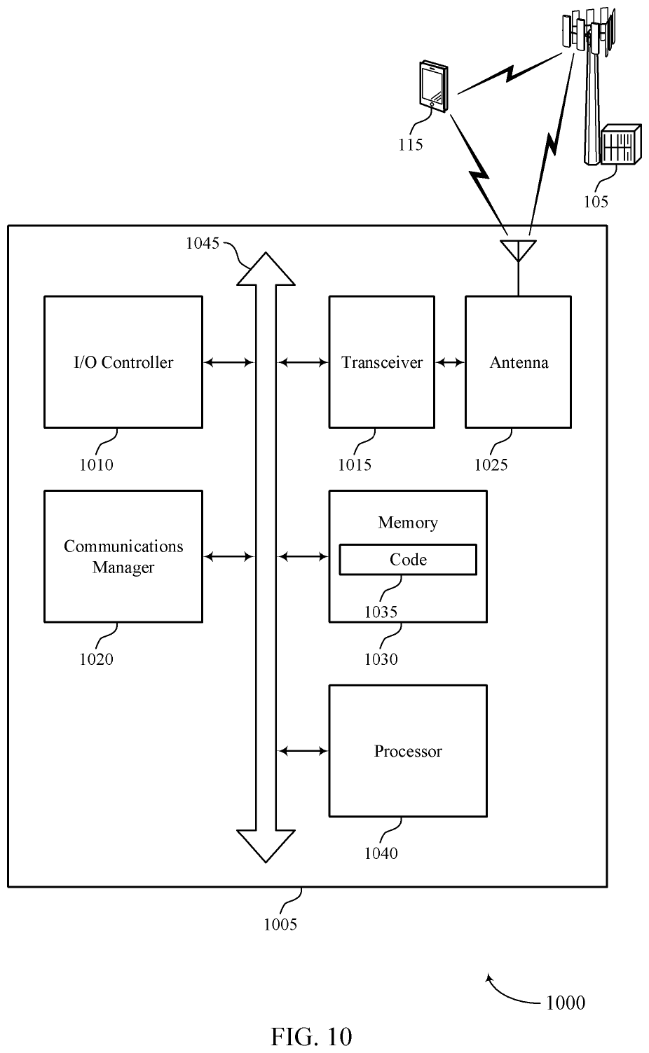

FIG. 10 shows a diagram of a system 1000 including a device 1005 that supports initial access and device identification protocol design for passive IoT in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting initial access and device identification protocol design for passive IoT). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a passive UE in accordance with examples as disclosed herein. For example, the communications manager 1020 may be configured as or otherwise support a means for receiving, from a network entity, an initial access trigger message including an indication of a first type of passive UE of a set of multiple types of passive UEs. The communications manager 1020 may be configured as or otherwise support a means for selecting one or more initial access resources based on the passive UE being the first type of passive UE. The communications manager 1020 may be configured as or otherwise support a means for transmitting, to the network entity on the one or more initial access resources, an initial access response message including an identifier associated with the passive UE.

By including or configuring the communications manager 1020 in accordance with examples as described herein, the device 1005 may support techniques for improved communication reliability, reduced latency, improved user experience related to faster processing, safer working environments due to reduced latency, reduced power consumption, reduced loss of data, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of initial access and device identification protocol design for passive IoT as described herein, or the processor 1040 and the memory 1030 may be otherwise configured to perform or support such operations.

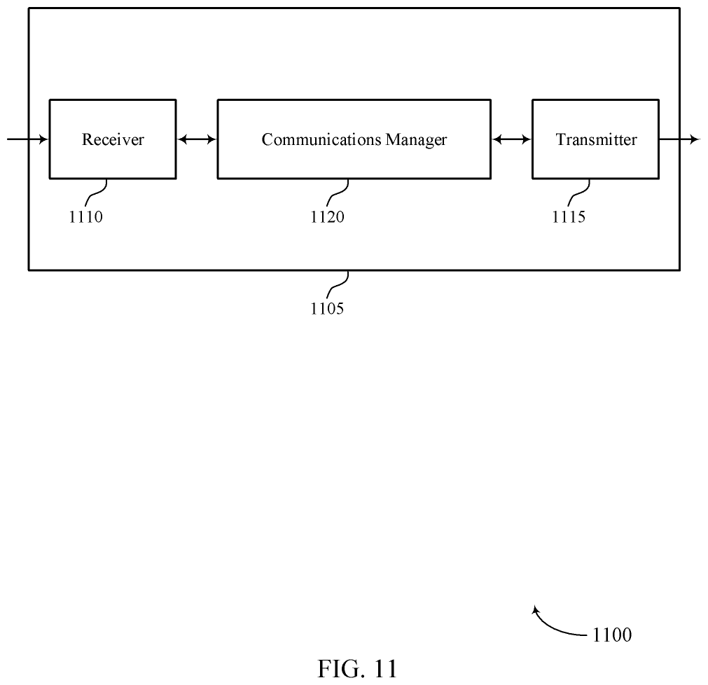

FIG. 11 shows a block diagram 1100 of a device 1105 that supports initial access and device identification protocol design for passive IoT in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of initial access and device identification protocol design for passive IoT as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a graphics processing unit (GPU), an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting, to a first passive UE, an initial access trigger message including an indication of a first type of passive UE of a set of multiple types of passive UEs. The communications manager 1120 may be configured as or otherwise support a means for receiving, from the first passive UE based on the first passive UE being the first type of UE, an initial access response message on one or more initial access resources, the initial access response message including an identifier associated with the passive UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced power consumption, reduced latency in communications, faster processing, and efficient utilization of communication resources.

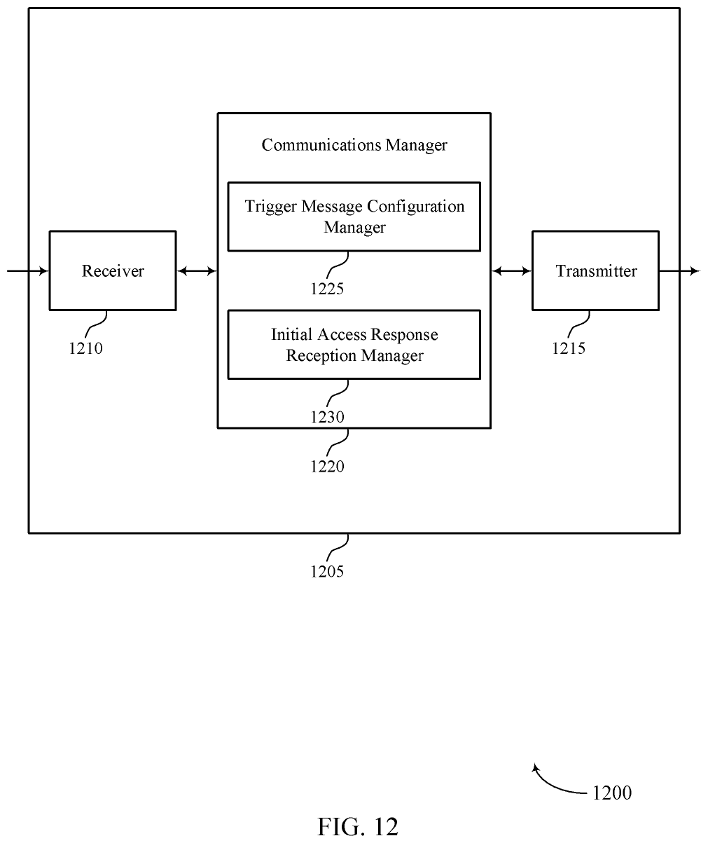

FIG. 12 shows a block diagram 1200 of a device 1205 that supports initial access and device identification protocol design for passive IoT in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of initial access and device identification protocol design for passive IoT as described herein. For example, the communications manager 1220 may include a trigger message configuration manager 1225 an initial access response reception manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The trigger message configuration manager 1225 may be configured as or otherwise support a means for transmitting, to a first passive UE, an initial access trigger message including an indication of a first type of passive UE of a set of multiple types of passive UEs. The initial access response reception manager 1230 may be configured as or otherwise support a means for receiving, from the first passive UE based on the first passive UE being the first type of UE, an initial access response message on one or more initial access resources, the initial access response message including an identifier associated with the passive UE.

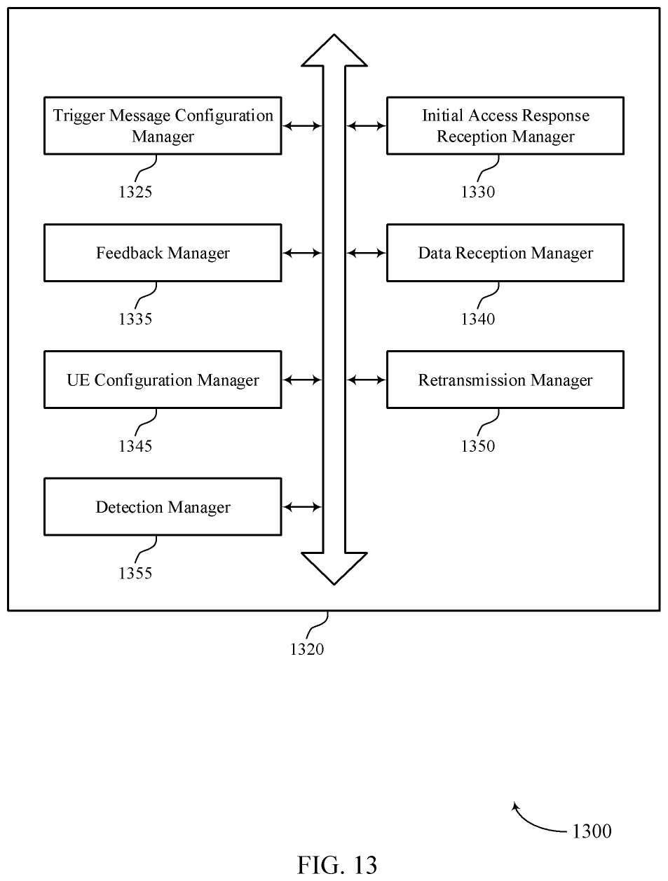

FIG. 13 shows a block diagram 1300 of a communications manager 1320 that supports initial access and device identification protocol design for passive IoT in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of initial access and device identification protocol design for passive IoT as described herein. For example, the communications manager 1320 may include a trigger message configuration manager 1325, an initial access response reception manager 1330, a feedback manager 1335, a data reception manager 1340, a UE configuration manager 1345, a retransmission manager 1350, a detection manager 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The trigger message configuration manager 1325 may be configured as or otherwise support a means for transmitting, to a first passive UE, an initial access trigger message including an indication of a first type of passive UE of a set of multiple types of passive UEs. The initial access response reception manager 1330 may be configured as or otherwise support a means for receiving, from the first passive UE based on the first passive UE being the first type of UE, an initial access response message on one or more initial access resources, the initial access response message including an identifier associated with the passive UE.

In some examples, the feedback manager 1335 may be configured as or otherwise support a means for transmitting, to the first passive UE based on receiving the initial access response message, an initial access acknowledgment message including the identifier associated with the first passive UE. In some examples, the data reception manager 1340 may be configured as or otherwise support a means for receiving, based on the initial access acknowledgment message, a data message from the first passive UE.

In some examples, the UE configuration manager 1345 may be configured as or otherwise support a means for transmitting, to the first passive UE, an indication of a set of multiple candidate muting ratios associated with the first type of passive UE, each muting ratio of the set of multiple candidate muting ratios indicating a respective ratio between a number of initial access response messages and a set of periodic initial access trigger messages including the initial access trigger message, where receiving the initial access response message is based on transmitting the indication of the set of multiple candidate muting ratios, and where the first type of passive UE is associated with pre-stored sensor data transmissions of a first priority level and the second type of passive UE is associated with sensor data transmissions of a second priority level that is lower than the first priority level.

In some examples, the UE configuration manager 1345 may be configured as or otherwise support a means for transmitting, to the first passive UE, a first configuration message indicating a periodicity of a set of multiple access frames associated with the first type of passive UE and a number of available access frames of the set of multiple access frames during a first period, where a first access frame of the set of multiple access frames includes the one or more initial access resources, where the first type of passive UE is associated with pre-stored sensor data transmissions of a first priority level and the second type of passive UE is associated with sensor data transmissions of a second priority level that is higher than the first priority level.

In some examples, the UE configuration manager 1345 may be configured as or otherwise support a means for transmitting, to the first passive UE, a second configuration message including an indication of a number of time resources associated with each respective access frame of the set of multiple access frames during the first period, a number of frequency resources associated with each respective access frame of the set of multiple access frames during the first period, or a combination thereof.

In some examples, the detection manager 1355 may be configured as or otherwise support a means for detecting a number of collisions during the first period between a set of multiple passive UEs including the first passive UE, a number of idle resources of the number of time resources, the number of frequency resources, or both, or any combination thereof. In some examples, the UE configuration manager 1345 may be configured as or otherwise support a means for transmitting, to the set of multiple passive UEs based on the detecting, a third configuration message including an indication of a second number of time resources associated with each respective access frame of the set of multiple access frames during a second period, a second number of frequency resources associated with each respective access frame of the set of multiple access frames during the second period, or a combination thereof.

In some examples, the UE configuration manager 1345 may be configured as or otherwise support a means for transmitting, to the first passive UE, an instruction to adjusting a response rate, a muting ratio, or a combination thereof, based on receiving the initial access response message.

In some examples, the retransmission manager 1350 may be configured as or otherwise support a means for transmitting, to the first passive UE based on a failure to receive the initial access response message during a first time period, an instruction to retransmit the initial access response message, where receiving the initial access response message is based on transmitting the instruction.

In some examples, the retransmission manager 1350 may be configured as or otherwise support a means for including, in the instruction to retransmit the initial access response message, an indication of a subset of retransmission resources of a set of multiple retransmission resources during which the passive UE is permitted to retransmit the initial access response message, where receiving the initial access response message includes receiving the initial access response message during at least one of the subset of retransmission resources.

In some examples, the UE configuration manager 1345 may be configured as or otherwise support a means for transmitting, to the first passive UE, an indication of a supported frequency shift for subcarrier modulation by the first passive UE, where receiving the initial access response message is based on the indication of the supported frequency shift.

In some examples, the trigger message configuration manager 1325 may be configured as or otherwise support a means for transmitting, to a second passive UE, a second initial access trigger message including an indication of a second type of passive UE of the set of multiple types of passive UEs. In some examples, the initial access response reception manager 1330 may be configured as or otherwise support a means for receiving, from the second passive UE based on the second passive UE being the second type of UE, a second initial access response message on one or more initial access resources associated with the second type of passive UE, the second initial access response message including an identifier associated with the second passive UE.

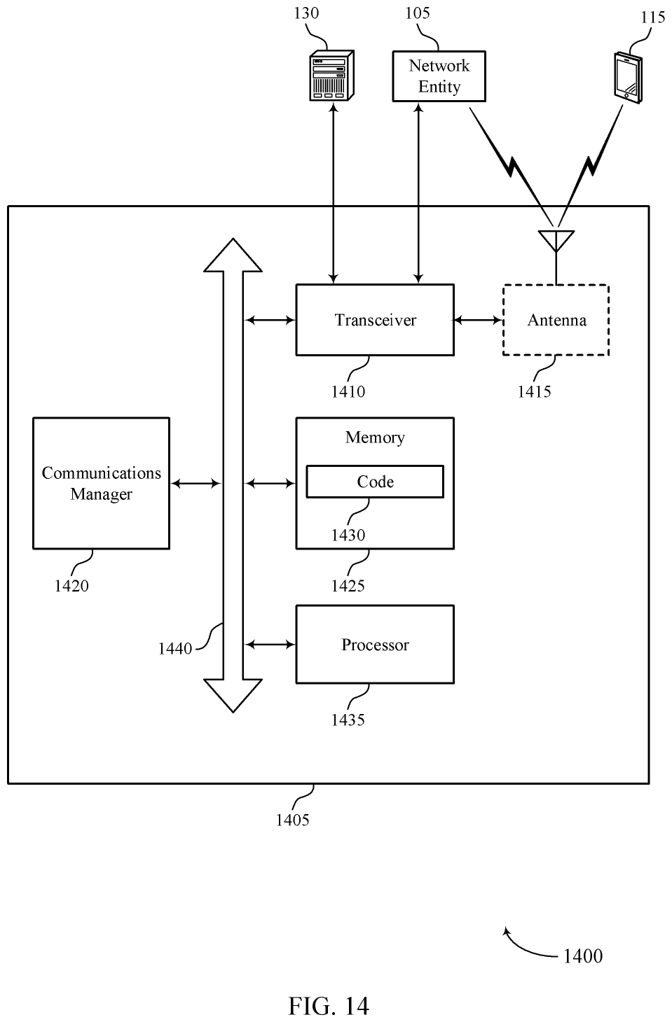

FIG. 14 shows a diagram of a system 1400 including a device 1405 that supports initial access and device identification protocol design for passive IoT in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting initial access and device identification protocol design for passive IoT). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, to a first passive UE, an initial access trigger message including an indication of a first type of passive UE of a set of multiple types of passive UEs. The communications manager 1420 may be configured as or otherwise support a means for receiving, from the first passive UE based on the first passive UE being the first type of UE, an initial access response message on one or more initial access resources, the initial access response message including an identifier associated with the passive UE.

By including or configuring the communications manager 1420 in accordance with examples as described herein, the device 1405 may support techniques for improved communication reliability, reduced latency, improved user experience related to faster processing, safer working environments due to reduced latency, reduced power consumption, reduced loss of data, and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of initial access and device identification protocol design for passive IoT as described herein, or the processor 1435 and the memory 1425 may be otherwise configured to perform or support such operations.

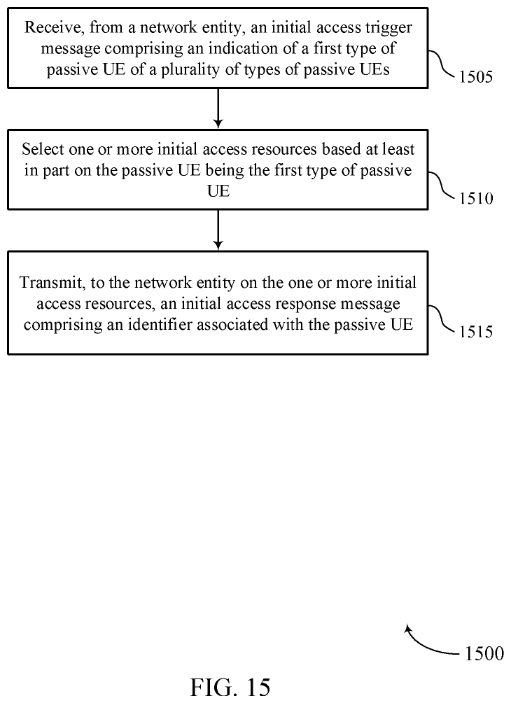

FIG. 15 shows a flowchart illustrating a method 1500 that supports initial access and device identification protocol design for passive IoT in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, an initial access trigger message including an indication of a first type of passive UE of a set of multiple types of passive UEs. The operations of 1505 may be performed in accordance with examples as disclosed herein. In some examples, aspects of the operations of 1505 may be performed by a trigger message reception manager 925 as described with reference to FIG. 9.

At 1510, the method may include selecting one or more initial access resources based at least in part on the passive UE being the first type of passive UE. The operations of 1510 may be performed in accordance with examples as disclosed herein. In some examples, aspects of the operations of 1510 may be performed by an initial access resource configuration manager 930 as described with reference to FIG. 9.

At 1515, the method may include transmitting, to the network entity on the one or more initial access resources, an initial access response message including an identifier associated with the passive UE. The operations of 1515 may be performed in accordance with examples as disclosed herein. In some examples, aspects of the operations of 1515 may be performed by an initial access response manager 935 as described with reference to FIG. 9.

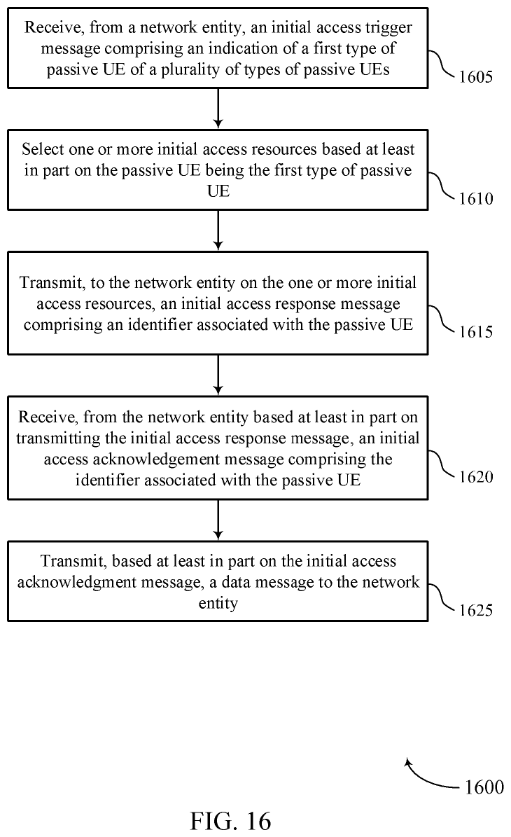

FIG. 16 shows a flowchart illustrating a method 1600 that supports initial access and device identification protocol design for passive IoT in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, an initial access trigger message including an indication of a first type of passive UE of a set of multiple types of passive UEs. The operations of 1605 may be performed in accordance with examples as disclosed herein. In some examples, aspects of the operations of 1605 may be performed by a trigger message reception manager 925 as described with reference to FIG. 9.

At 1610, the method may include selecting one or more initial access resources based at least in part on the passive UE being the first type of passive UE. The operations of 1610 may be performed in accordance with examples as disclosed herein. In some examples, aspects of the operations of 1610 may be performed by an initial access resource configuration manager 930 as described with reference to FIG. 9.

At 1615, the method may include transmitting, to the network entity on the one or more initial access resources, an initial access response message including an identifier associated with the passive UE. The operations of 1615 may be performed in accordance with examples as disclosed herein. In some examples, aspects of the operations of 1615 may be performed by an initial access response manager 935 as described with reference to FIG. 9.

At 1620, the method may include receiving, from the network entity based at least in part on transmitting the initial access response message, an initial access acknowledgment message including the identifier associated with the passive UE. The operations of 1620 may be performed in accordance with examples as disclosed herein. In some examples, aspects of the operations of 1620 may be performed by a feedback manager 940 as described with reference to FIG. 9.

At 1625, the method may include transmitting, based at least in part on the initial access acknowledgment message, a data message to the network entity. The operations of 1625 may be performed in accordance with examples as disclosed herein. In some examples, aspects of the operations of 1625 may be performed by a data transmission manager 945 as described with reference to FIG. 9.

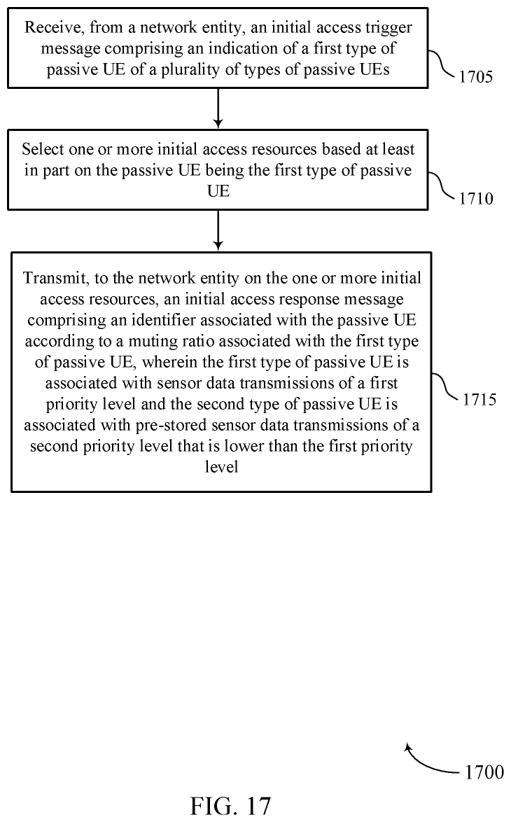

FIG. 17 shows a flowchart illustrating a method 1700 that supports initial access and device identification protocol design for passive IoT in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, an initial access trigger message including an indication of a first type of passive UE of a set of multiple types of passive UEs. The operations of 1705 may be performed in accordance with examples as disclosed herein. In some examples, aspects of the operations of 1705 may be performed by a trigger message reception manager 925 as described with reference to FIG. 9.

At 1710, the method may include selecting one or more initial access resources based at least in part on the passive UE being the first type of passive UE. The operations of 1710 may be performed in accordance with examples as disclosed herein. In some examples, aspects of the operations of 1710 may be performed by an initial access resource configuration manager 930 as described with reference to FIG. 9.

At 1715, the method may include transmitting, to the network entity on the one or more initial access resources, an initial access response message including an identifier associated with the passive UE according to a muting ratio associated with the first type of passive UE, wherein the first type of passive UE is associated with sensor data transmissions of a first priority level and the second type of passive UE is associated with pre-stored sensor data transmissions of a second priority level that is lower than the first priority level. The operations of 1715 may be performed in accordance with examples as disclosed herein. In some examples, aspects of the operations of 1715 may be performed by an initial access response manager 935 as described with reference to FIG. 9.

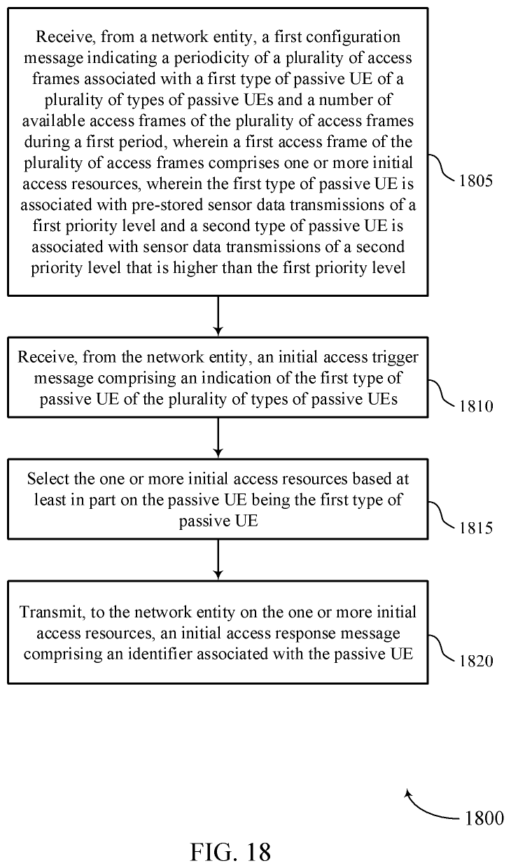

FIG. 18 shows a flowchart illustrating a method 1800 that supports initial access and device identification protocol design for passive IoT in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, a first configuration message indicating a periodicity of a set of multiple access frames associated with a first type of passive UE of a set of multiple types of passive UEs and a number of available access frames of the set of multiple access frames during a first period, where a first access frame of the set of multiple access frames includes one or more initial access resources, where the first type of passive UE is associated with pre-stored sensor data transmissions of a first priority level and a second type of passive UE is associated with sensor data transmissions of a second priority level that is higher than the first priority level. The operations of 1805 may be performed in accordance with examples as disclosed herein. In some examples, aspects of the operations of 1805 may be performed by a UE configuration reception manager 950 as described with reference to FIG. 9.

At 1810, the method may include receiving, from a network entity, an initial access trigger message including an indication of the first type of passive UE of the set of multiple types of passive UEs. The operations of 1810 may be performed in accordance with examples as disclosed herein. In some examples, aspects of the operations of 1810 may be performed by a trigger message reception manager 925 as described with reference to FIG. 9.

At 1815, the method may include selecting the one or more initial access resources based at least in part on the passive UE being the first type of passive UE. The operations of 1815 may be performed in accordance with examples as disclosed herein. In some examples, aspects of the operations of 1815 may be performed by an initial access resource configuration manager 930 as described with reference to FIG. 9.

At 1820, the method may include transmitting, to the network entity on the one or more initial access resources, an initial access response message including an identifier associated with the passive UE. The operations of 1820 may be performed in accordance with examples as disclosed herein. In some examples, aspects of the operations of 1820 may be performed by an initial access response manager 935 as described with reference to FIG. 9.

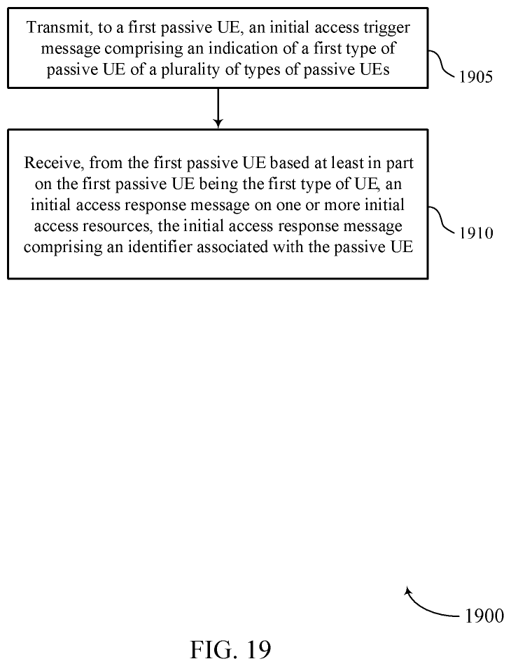

FIG. 19 shows a flowchart illustrating a method 1900 that supports initial access and device identification protocol design for passive IoT in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a first passive UE, an initial access trigger message including an indication of a first type of passive UE of a set of multiple types of passive UEs. The operations of 1905 may be performed in accordance with examples as disclosed herein. In some examples, aspects of the operations of 1905 may be performed by a trigger message configuration manager 1325 as described with reference to FIG. 13.

At 1910, the method may include receiving, from the first passive UE based at least in part on the first passive UE being the first type of UE, an initial access response message on one or more initial access resources, the initial access response message including an identifier associated with the passive UE. The operations of 1910 may be performed in accordance with examples as disclosed herein. In some examples, aspects of the operations of 1910 may be performed by an initial access response reception manager 1330 as described with reference to FIG. 13.

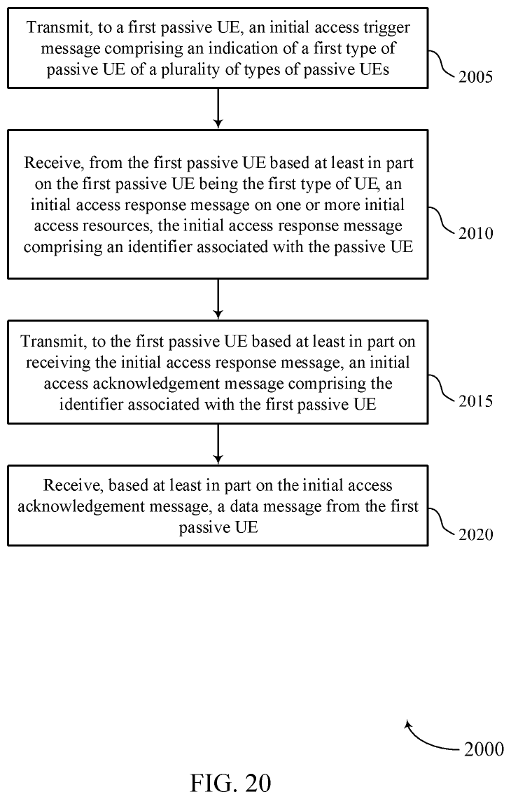

FIG. 20 shows a flowchart illustrating a method 2000 that supports initial access and device identification protocol design for passive IoT in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a first passive UE, an initial access trigger message including an indication of a first type of passive UE of a set of multiple types of passive UEs. The operations of 2005 may be performed in accordance with examples as disclosed herein. In some examples, aspects of the operations of 2005 may be performed by a trigger message configuration manager 1325 as described with reference to FIG. 13.

At 2010, the method may include receiving, from the first passive UE based at least in part on the first passive UE being the first type of UE, an initial access response message on one or more initial access resources, the initial access response message including an identifier associated with the passive UE. The operations of 2010 may be performed in accordance with examples as disclosed herein. In some examples, aspects of the operations of 2010 may be performed by an initial access response reception manager 1330 as described with reference to FIG. 13.

At 2015, the method may include transmitting, to the first passive UE based at least in part on receiving the initial access response message, an initial access acknowledgment message including the identifier associated with the first passive UE. The operations of 2015 may be performed in accordance with examples as disclosed herein. In some examples, aspects of the operations of 2015 may be performed by a feedback manager 1335 as described with reference to FIG. 13.

At 2020, the method may include receiving, based at least in part on the initial access acknowledgment message, a data message from the first passive UE. The operations of 2020 may be performed in accordance with examples as disclosed herein. In some examples, aspects of the operations of 2020 may be performed by a data reception manager 1340 as described with reference to FIG. 13.

The following provides an overview of aspects of the present disclosure:

Aspect 1: A method for wireless communications at a passive UE, comprising: receiving, from a network entity, an initial access trigger message comprising an indication of a first type of passive UE of a plurality of types of passive UEs; selecting one or more initial access resources based at least in part on the passive UE being the first type of passive UE; and transmitting, to the network entity on the one or more initial access resources, an initial access response message comprising an identifier associated with the passive UE.

Aspect 2: The method of aspect 1, further comprising: receiving, from the network entity based at least in part on transmitting the initial access response message, an initial access acknowledgment message comprising the identifier associated with the passive UE; and transmitting, based at least in part on the initial access acknowledgment message, a data message to the network entity.

Aspect 3: The method of any of aspects 1 through 2, wherein transmitting the initial access response message comprises: transmitting the initial access response message according to a muting ratio associated with the first type of passive UE, wherein the first type of passive UE is associated with sensor data transmissions of a first priority level and the second type of passive UE is associated with pre-stored sensor data transmissions of a second priority level that is lower than the first priority level.

Aspect 4: The method of aspect 3, further comprising: selecting, based at least in part on an amount of time in a timing budget for transmitting the data message, the muting ratio from a plurality of candidate muting ratios of a plurality of candidate muting ratios, each muting ratio of the plurality of candidate muting ratios indicating a respective ratio between a number of initial access response messages and a set of periodic initial access trigger messages comprising the initial access trigger message, wherein the data message comprises high priority sensor data.

Aspect 5: The method of any of aspects 3 through 4, further comprising: receiving, from the network entity, an indication of the plurality of candidate muting ratios.

Aspect 6: The method of any of aspects 3 through 5, wherein transmitting the initial access response message comprises: generating a slot number associated with the one or more initial access resources from a set of slot numbers, wherein the initial access trigger message comprises an indication of the set of slot numbers; and transmitting the initial access response message when the generated slot number satisfies a condition.

Aspect 7: The method of any of aspects 1 through 6, further comprising: receiving, from then network entity, a first configuration message indicating a periodicity of a plurality of access frames associated with the first type of passive UE and a number of available access frames of the plurality of access frames during a first period, wherein a first access frame of the plurality of access frames comprises the one or more initial access resources, wherein the first type of passive UE is associated with pre-stored sensor data transmissions of a first priority level and the second type of passive UE is associated with sensor data transmissions of a second priority level that is higher than the first priority level.

Aspect 8: The method of aspect 7, further comprising: determining the first access frame from the plurality of access frames based at least in part on an identifier associated with the passive UE, the periodicity, the number of available access frames, or a combination thereof; and randomly selecting the one or more initial access resources from a set of time resources associated with the first access frame, a set of frequency resources associated with the first access frame, or both.

Aspect 9: The method of any of aspects 7 through 8, further comprising: receiving, from the network entity, a second configuration message comprising an indication of a number of time resources associated with each respective access frame of the plurality of access frames during the first period, a number of frequency resources associated with each respective access frame of the plurality of access frames during the first period, or a combination thereof.

Aspect 10: The method of aspect 9, further comprising: receiving, from the network entity, a third configuration message comprising an indication of a second number of time resources associated with each respective access frame of the plurality of access frames during a second period, a second number of frequency resources associated with each respective access frame of the plurality of access frames during the second period, or a combination thereof.

Aspect 11: The method of any of aspects 1 through 10, further comprising: receiving, from the network entity, a second initial access trigger message comprising a second indication of the first type of passive UE; and refraining from transmitting a second initial access response message based at least in part on transmitting the initial access response message.

Aspect 12: The method of aspect 11, further comprising: adjusting a response rate, a muting ratio, or a combination thereof, based at least in part on transmitting the initial access response message, wherein the refraining is based at least in part on the adjusting.

Aspect 13: The method of any of aspects 1 through 12, further comprising: receiving, from the network entity based at least in part on transmitting the initial access response message, an instruction to retransmit the initial access response message; and retransmitting the initial access response message to the network entity based at least in part on the instruction.

Aspect 14: The method of aspect 13, further comprising: receiving, in the instruction to retransmit the initial access response message, an indication of a subset of retransmission resources of a plurality of retransmission resources during which the passive UE is permitted to retransmit the initial access response message; and determining a response rate for a retransmission of the initial access response message wherein retransmitting the initial access response message comprises retransmitting the initial access response message according to the response rate using one or more of the subset of retransmission resources.

Aspect 15: The method of any of aspects 1 through 14, further comprising: receiving, from the network entity, an indication of a supported frequency shift for subcarrier modulation; and performing, based at least in part on the supported frequency shift and a number of frequency channels indicated for the one or more initial access resources in the initial access trigger message, a subcarrier modulation procedure, wherein transmitting the initial access response message is based at least in part on the subcarrier modulation procedure.

Aspect 16: The method of any of aspects 1 through 15, wherein transmitting the initial access response message comprises: modulating a first carrier signal associated with the initial access trigger message; and backscattering a second carrier signal based at least in part on the modulated first carrier signal, wherein the second carrier signal comprises the initial access response message.

Aspect 17: A method for wireless communications at a network entity, comprising: transmitting, to a first passive UE, an initial access trigger message comprising an indication of a first type of passive UE of a plurality of types of passive UEs; and receiving, from the first passive UE based at least in part on the first passive UE being the first type of UE, an initial access response message on one or more initial access resources, the initial access response message comprising an identifier associated with the passive UE.

Aspect 18: The method of aspect 17, further comprising: transmitting, to the first passive UE based at least in part on receiving the initial access response message, an initial access acknowledgment message comprising the identifier associated with the first passive UE; and receiving, based at least in part on the initial access acknowledgment message, a data message from the first passive UE.

Aspect 19: The method of any of aspects 17 through 18, further comprising: transmitting, to the first passive UE, an indication of a plurality of candidate muting ratios associated with the first type of passive UE, each muting ratio of the plurality of candidate muting ratios indicating a respective ratio between a number of initial access response messages and a set of periodic initial access trigger messages comprising the initial access trigger message, wherein receiving the initial access response message is based at least in part on transmitting the indication of the plurality of candidate muting ratios, and wherein the first type of passive UE is associated with pre-stored sensor data transmissions of a first priority level and the second type of passive UE is associated with sensor data transmissions of a second priority level that is lower than the first priority level.

Aspect 20: The method of any of aspects 17 through 19, further comprising: transmitting, to the first passive UE, a first configuration message indicating a periodicity of a plurality of access frames associated with the first type of passive UE and a number of available access frames of the plurality of access frames during a first period, wherein a first access frame of the plurality of access frames comprises the one or more initial access resources, wherein the first type of passive UE is associated with pre-stored sensor data transmissions of a first priority level and the second type of passive UE is associated with sensor data transmissions of a second priority level that is higher than the first priority level.

Aspect 21: The method of aspect 20, further comprising: transmitting, to the first passive UE, a second configuration message comprising an indication of a number of time resources associated with each respective access frame of the plurality of access frames during the first period, a number of frequency resources associated with each respective access frame of the plurality of access frames during the first period, or a combination thereof.

Aspect 22: The method of aspect 21, further comprising: detecting a number of collisions during the first period between a plurality of passive UEs comprising the first passive UE, a number of idle resources of the number of time resources, the number of frequency resources, or both, or any combination thereof; and transmitting, to the plurality of passive UEs based at least in part on the detecting, a third configuration message comprising an indication of a second number of time resources associated with each respective access frame of the plurality of access frames during a second period, a second number of frequency resources associated with each respective access frame of the plurality of access frames during the second period, or a combination thereof.

Aspect 23: The method of any of aspects 17 through 22, further comprising: transmitting, to the first passive UE, an instruction to adjusting a response rate, a muting ratio, or a combination thereof, based at least in part on receiving the initial access response message.

Aspect 24: The method of any of aspects 17 through 23, further comprising: transmitting, to the first passive UE based at least in part on a failure to receive the initial access response message during a first time period, an instruction to retransmit the initial access response message, wherein receiving the initial access response message is based at least in part on transmitting the instruction.

Aspect 25: The method of aspect 24, further comprising: including, in the instruction to retransmit the initial access response message, an indication of a subset of retransmission resources of a plurality of retransmission resources during which the passive UE is permitted to retransmit the initial access response message, wherein receiving the initial access response message comprises receiving the initial access response message during at least one of the subset of retransmission resources.

Aspect 26: The method of any of aspects 17 through 25, further comprising: transmitting, to the first passive UE, an indication of a supported frequency shift for subcarrier modulation by the first passive UE, wherein receiving the initial access response message is based at least in part on the indication of the supported frequency shift.

Aspect 27: The method of any of aspects 17 through 26, further comprising: transmitting, to a second passive UE, a second initial access trigger message comprising an indication of a second type of passive UE of the plurality of types of passive UEs; and receiving, from the second passive UE based at least in part on the second passive UE being the second type of UE, a second initial access response message on one or more initial access resources associated with the second type of passive UE, the second initial access response message comprising an identifier associated with the second passive UE.

Aspect 28: An apparatus for wireless communications at a passive UE, comprising at least one processor; and memory coupled to the at least one processor, the memory storing instructions executable by the at least one processor to cause the apparatus to perform a method of any of aspects 1 through 16.

Aspect 29: An apparatus for wireless communications at a passive UE, comprising at least one means for performing a method of any of aspects 1 through 16.

Aspect 30: A non-transitory computer-readable medium storing code for wireless communication, the code comprising instructions executable by at least one processor to perform a method of any of aspects 1 through 16.

Aspect 31: An apparatus for wireless communications at a network entity, comprising at least one processor; and memory coupled to the at least one processor, the memory storing instructions executable by the at least one processor to cause the apparatus to perform a method of any of aspects 17 through 27.

Aspect 32: An apparatus for wireless communications at a network entity, comprising at least one means for performing a method of any of aspects 17 through 27.

Aspect 33: A non-transitory computer-readable medium storing code for wireless communication, the code comprising instructions executable by at least one processor to perform a method of any of aspects 17 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a passive user equipment (UE), comprising:
receiving, from a network entity, an initial access trigger message comprising an indication of a first type of passive UE of a plurality of types of passive UEs;
selecting one or more initial access resources based at least in part on the passive UE being the first type of passive UE; and
transmitting, to the network entity on the one or more initial access resources, an initial access response message comprising an identifier associated with the passive UE.

2. The method of claim 1, further comprising:
receiving, from the network entity based at least in part on transmitting the initial access response message, an initial access acknowledgment message comprising the identifier associated with the passive UE; and
transmitting, based at least in part on the initial access acknowledgment message, a data message to the network entity.

3. The method of claim 1, wherein transmitting the initial access response message comprises:
transmitting the initial access response message according to a muting ratio associated with the first type of passive UE, wherein the first type of passive UE is associated with sensor data transmissions of a first priority level and a second type of passive UE is associated with pre-stored sensor data transmissions of a second priority level that is lower than the first priority level.

4. The method of claim 3, further comprising:
selecting, based at least in part on an amount of time in a timing budget for transmitting a data message, the muting ratio from a plurality of candidate muting ratios of a plurality of candidate muting ratios, each muting ratio of the plurality of candidate muting ratios indicating a respective ratio between a number of initial access response messages and a set of periodic initial access trigger messages comprising the initial access trigger message, wherein the data message comprises high priority sensor data.

5. The method of claim 4, further comprising:
receiving, from the network entity, an indication of the plurality of candidate muting ratios.

6. The method of claim 3, wherein transmitting the initial access response message comprises:
generating a slot number associated with the one or more initial access resources from a set of slot numbers, wherein the initial access trigger message comprises an indication of the set of slot numbers; and
transmitting the initial access response message when the generated slot number satisfies a condition.

7. The method of claim 1, further comprising:
receiving, from then network entity, a first configuration message indicating a periodicity of a plurality of access frames associated with the first type of passive UE and a number of available access frames of the plurality of access frames during a first period, wherein a first access frame of the plurality of access frames comprises the one or more initial access resources, wherein the first type of passive UE is associated with pre-stored sensor data transmissions of a first priority level and a second type of passive UE is associated with sensor data transmissions of a second priority level that is higher than the first priority level.

8. The method of claim 7, further comprising:
determining the first access frame from the plurality of access frames based at least in part on an identifier associated with the passive UE, the periodicity, the number of available access frames, or a combination thereof; and
randomly selecting the one or more initial access resources from a set of time resources associated with the first access frame, a set of frequency resources associated with the first access frame, or both.

9. The method of claim 7, further comprising:
receiving, from the network entity, a second configuration message comprising an indication of a number of time resources associated with each respective access frame of the plurality of access frames during the first period, a number of frequency resources associated with each respective access frame of the plurality of access frames during the first period, or a combination thereof.

10. The method of claim 9, further comprising:
receiving, from the network entity, a third configuration message comprising an indication of a second number of time resources associated with each respective access frame of the plurality of access frames during a second period, a second number of frequency resources associated with each respective access frame of the plurality of access frames during the second period, or a combination thereof.

11. The method of claim 1, further comprising:
receiving, from the network entity, a second initial access trigger message comprising a second indication of the first type of passive UE; and
refraining from transmitting a second initial access response message based at least in part on transmitting the initial access response message.

12. The method of claim 11, further comprising:
adjusting a response rate, a muting ratio, or a combination thereof, based at least in part on transmitting the initial access response message, wherein the refraining is based at least in part on the adjusting.

13. The method of claim 1, further comprising:
receiving, from the network entity based at least in part on transmitting the initial access response message, an instruction to retransmit the initial access response message; and
retransmitting the initial access response message to the network entity based at least in part on the instruction.

14. The method of claim 13, further comprising:
receiving, in the instruction to retransmit the initial access response message, an indication of a subset of retransmission resources of a plurality of retransmission resources during which the passive UE is permitted to retransmit the initial access response message; and
determining a response rate for a retransmission of the initial access response message wherein retransmitting the initial access response message comprises retransmitting the initial access response message according to the response rate using one or more of the subset of retransmission resources.

15. The method of claim 1, further comprising:
receiving, from the network entity, an indication of a supported frequency shift for subcarrier modulation; and
performing, based at least in part on the supported frequency shift and a number of frequency channels indicated for the one or more initial access resources in the initial access trigger message, a subcarrier modulation procedure, wherein transmitting the initial access response message is based at least in part on the subcarrier modulation procedure.

16. The method of claim 1, wherein transmitting the initial access response message comprises:
modulating a first carrier signal associated with the initial access trigger message; and
backscattering a second carrier signal based at least in part on the modulated first carrier signal, wherein the second carrier signal comprises the initial access response message.

17. A method for wireless communications at a network entity, comprising:
transmitting, to a first passive UE, an initial access trigger message comprising an indication of a first type of passive UE of a plurality of types of passive UEs; and
receiving, from the first passive UE based at least in part on the first passive UE being the first type of UE, an initial access response message on one or more initial access resources, the initial access response message comprising an identifier associated with the passive UE.

18. The method of claim 17, further comprising:
transmitting, to the first passive UE based at least in part on receiving the initial access response message, an initial access acknowledgment message comprising the identifier associated with the first passive UE; and
receiving, based at least in part on the initial access acknowledgment message, a data message from the first passive UE.

19. The method of claim 17, further comprising:
transmitting, to the first passive UE, an indication of a plurality of candidate muting ratios associated with the first type of passive UE, each muting ratio of the plurality of candidate muting ratios indicating a respective ratio between a number of initial access response messages and a set of periodic initial access trigger messages comprising the initial access trigger message, wherein receiving the initial access response message is based at least in part on transmitting the indication of the plurality of candidate muting ratios, and wherein the first type of passive UE is associated with pre-stored sensor data transmissions of a first priority level and a second type of passive UE is associated with sensor data transmissions of a second priority level that is lower than the first priority level.

20. The method of claim 17, further comprising:
transmitting, to the first passive UE, a first configuration message indicating a periodicity of a plurality of access frames associated with the first type of passive UE and a number of available access frames of the plurality of access frames during a first period, wherein a first access frame of the plurality of access frames comprises the one or more initial access resources, wherein the first type of passive UE is associated with pre-stored sensor data transmissions of a first priority level and a second type of passive UE is associated with sensor data transmissions of a second priority level that is higher than the first priority level.

21. The method of claim 20, further comprising:
transmitting, to the first passive UE, a second configuration message comprising an indication of a number of time resources associated with each respective access frame of the plurality of access frames during the first period, a number of frequency resources associated with each respective access frame of the plurality of access frames during the first period, or a combination thereof.

22. The method of claim 21, further comprising:
detecting a number of collisions during the first period between a plurality of passive UEs comprising the first passive UE, a number of idle resources of the number of time resources, the number of frequency resources, or both, or any combination thereof; and
transmitting, to the plurality of passive UEs based at least in part on the detecting, a third configuration message comprising an indication of a second number of time resources associated with each respective access frame of the plurality of access frames during a second period, a second number of frequency resources associated with each respective access frame of the plurality of access frames during the second period, or a combination thereof.

23. The method of claim 17, further comprising:
transmitting, to the first passive UE, an instruction to adjusting a response rate, a muting ratio, or a combination thereof, based at least in part on receiving the initial access response message.

24. The method of claim 17, further comprising:
transmitting, to the first passive UE based at least in part on a failure to receive the initial access response message during a first time period, an instruction to retransmit the initial access response message, wherein receiving the initial access response message is based at least in part on transmitting the instruction.

25. The method of claim 24, further comprising:
including, in the instruction to retransmit the initial access response message, an indication of a subset of retransmission resources of a plurality of retransmission resources during which the passive UE is permitted to retransmit the initial access response message, wherein receiving the initial access response message comprises receiving the initial access response message during at least one of the subset of retransmission resources.

26. The method of claim 17, further comprising:
transmitting, to the first passive UE, an indication of a supported frequency shift for subcarrier modulation by the first passive UE, wherein receiving the initial access response message is based at least in part on the indication of the supported frequency shift.

27. The method of claim 17, further comprising:
transmitting, to a second passive UE, a second initial access trigger message comprising an indication of a second type of passive UE of the plurality of types of passive UEs; and
receiving, from the second passive UE based at least in part on the second passive UE being the second type of UE, a second initial access response message on one or more initial access resources associated with the second type of passive UE, the second initial access response message comprising an identifier associated with the second passive UE.

28. An apparatus for wireless communications at a passive user equipment (UE), comprising:
at least one processor; and
memory coupled to the at least one processor, the memory storing instructions executable by the at least one processor to cause the apparatus to:
receive, from a network entity, an initial access trigger message comprising an indication of a first type of passive UE of a plurality of types of passive UEs;
select one or more initial access resources based at least in part on the passive UE being the first type of passive UE; and
transmit, to the network entity on the one or more initial access resources, an initial access response message comprising an identifier associated with the passive UE.

29. The apparatus of claim 28, wherein the instructions are further executable by the at least one processor to cause the apparatus to:
receive, from the network entity based at least in part on transmitting the initial access response message, an initial access acknowledgment message comprising the identifier associated with the passive UE; and
transmit, based at least in part on the initial access acknowledgment message, a data message to the network entity.

30. An apparatus for wireless communications at a network entity, comprising:
at least one processor; and
memory coupled to the at least one processor, the memory storing instructions executable by the at least one processor to cause the apparatus to:
transmit, to a first passive UE, an initial access trigger message comprising an indication of a first type of passive UE of a plurality of types of passive UEs; and
receive, from the first passive UE based at least in part on the first passive UE being the first type of UE, an initial access response message on one or more initial access resources, the initial access response message comprising an identifier associated with the passive UE.
